(19) United States
(12) Patent Application Publication
(10) Pub. No.: US 2026/0331767 A1
(43) Pub. Date: Oct. 22, 2026

(54) LENS AND ANTENNA ASSEMBLY

(71) Applicant: 3M INNOVATIVE PROPERTIES COMPANY, St. Paul, MN (US)

(72) Inventors: Zohaib Hameed, Woodbury, MN (US); Jaewon Kim, Woodbury, MN (US); Elias Wilken-Resman, Minneapolis, MN (US); Milo G. Oien-Rochat, Minneapolis, MN (US); Ian Cummings, Brookfield, WI (US); Jennifer J. Sokol, Mahtomedi, MN (US); Charles L. Bruzzone, Woodbury, MN (US); Lars Schrix, Duisburg (DE); Christian Weinmann, Alsdorf (DE); Jeffrey A. Tostenrude, Leander, TX (US); Marcus Schwarting, Bolingbrook, IL (US)

(21) Appl. No.: 19/113,082

(22) PCT Filed: Sep. 22, 2023
(86) PCT No.: PCT/IB2023/059408

§ 371 Date: Mar. 19, 2025

Related U.S. Application Data
(60) Provisional application No. 63/411,674, filed on Sep. 30, 2022.

(51) Int. Cl. H01Q 3/26

(52) U.S. Cl. CPC H01Q 3/2658

(57) ABSTRACT

A lens configured to be disposed on and substantially cover a plurality of spaced apart antenna elements of a phased array antenna is provided. The lens includes a structured first major surface opposite a second major surface. The structured first and second major surfaces define a reference plane disposed inclusive therebetween and closest to the structured first major surface. The structured first major surface includes a center and a first annular peak region surrounding, and substantially concentric with, the center. The first annular peak region has a first annular peak having an average separation P1 from the reference plane. A minimum separation between the structured first major surface and the reference plane inside the first annular peak is P2, wherein P1/P2≥2.

### TECHNICAL FIELD

The present disclosure relates to a lens and an antenna assembly including the lens.

### BACKGROUND

Directional antennas, such as phased array antennas, may not provide a wide-angle coverage (e.g., 120 degrees or more) without a significant gain degradation at wider scan angles. This may be due to an undesired beam broadening which is typically observed at the wider scan angles of the phased array antennas.

### SUMMARY

In a first aspect, the present disclosure provides a lens configured to be disposed on and substantially cover a plurality of spaced apart antenna elements of a phased array antenna. The lens includes a structured first major surface opposite a second major surface. The structured first and second major surfaces define a reference plane disposed inclusive therebetween and closest to the structured first major surface. The structured first major surface includes a center and a first annular peak region surrounding, and substantially concentric with, the center. The first annular peak region has a first annular peak having an average separation P1 from the reference plane. A minimum separation between the structured first major surface and the reference plane inside the first annular peak is P2, wherein P1/P2≥2.

In a second aspect, the present disclosure provides an antenna assembly. The antenna assembly includes a phased array antenna including a plurality of spaced apart antenna elements arranged in a plurality of rows and columns of the antenna elements and defining a first axis of symmetry. The antenna assembly further includes the lens of the first aspect disposed on and substantially covering the plurality of spaced apart antenna elements of the phased array antenna.

In a third aspect, the present disclosure provides a lens configured to be disposed on and substantially cover a plurality of spaced apart antenna elements of a phased array antenna. The lens includes a continuous closed annular first band including a corresponding continuous closed annular first band peak. The annular first band defines a cavity therein extending along a thickness direction of the lens from a first open end of the cavity at the first band peak to an opposite second end. The cavity has a maximum height Hc along the thickness direction of the lens. The first band has a height Hb1 along the thickness direction of the lens and a base having a width Wb1, wherein Hc/Hb1≥0.5, and wherein Hb1>Wb1.

In a fourth aspect, the present disclosure provides an antenna assembly. The antenna assembly includes a phased array antenna including a plurality of spaced apart antenna elements arranged in a plurality of rows and columns of the antenna elements and defining a first axis of symmetry. The antenna assembly further includes a non-spherical lens disposed on the phased array antenna and substantially covering at least some of the antenna elements. The non-spherical lens includes a non-spherical first major surface facing away from the antenna elements and an opposite second major surface facing the antenna elements. The non-spherical first major surface includes at least a curved portion curved along at least one direction. In a scan plane that includes the first axis of symmetry and a normal to the phased array antenna, the antenna assembly steers a beam in the scan plane having a maximum gain G1 and a 3 decibel (dB) beam width W1 when steered along a first direction making an angle of less than about 10 degrees with the normal and a maximum gain G2 and a 3 dB beam width W2 when steered along a second direction making an angle of no less than about 30 degrees with the normal. G1 and G2 are within 4 dB of each other. Further, W1 and W2 are within 15% of each other.

In a fifth aspect, the present disclosure provides a lens configured to be disposed on and substantially cover a plurality of spaced apart antenna elements of a phased array antenna. The lens includes a continuous closed annular first band including a corresponding continuous closed annular first band peak. The annular first band defines a cavity therein extending along a thickness direction of the lens. When the lens is disposed on and substantially covers the plurality of spaced apart antenna elements of the phased array antenna, then in a scan plane that includes a first axis of symmetry of the plurality of the antenna elements and a normal to the phased array antenna, the antenna elements steer a beam having a 3 dB beam width W and propagating in the scan plane along a scan direction making a scan angle with the normal. For a scan angle of greater than about 15 degrees over a scan angle range of at least 3 degrees, W varies by less than 5%.

In a sixth aspect, the present disclosure provides a lens configured to be disposed on a two-dimensional array of antenna elements. The lens defines a central cavity at or near a center of the lens. The cavity is surrounded by a continuous closed annular peak region having a continuous closed annulus peak. The lens and the annulus peak have respective maximum lateral dimensions T1 and T2, wherein T2/T1≤0.8.

In a seventh aspect, the present disclosure provides an antenna assembly. The antenna assembly includes a phased array antenna including a plurality of spaced apart antenna elements arranged in a plurality of rows and columns of the antenna elements and defining a first axis of symmetry. The antenna assembly further includes a non-spherical lens disposed on the phased array antenna and substantially covering at least some of the antenna elements. The non-spherical lens includes a non-spherical first major surface and an opposing second major surface. The non-spherical first major surface includes at least a curved portion curved along at least one direction. In a scan plane that includes the first axis of symmetry and a normal to the phased array antenna, the antenna assembly steers a beam in the scan plane having a 3 dB beam width having a plurality of alternating peaks and valleys. Each of at least two peaks in the plurality of alternating peaks and valleys has a full width at 95% maximum FW95M that is greater than about 2 degrees and less than about 20 degrees.

In an eighth aspect, the present disclosure provides an antenna assembly. The antenna assembly includes a phased array antenna including a plurality of spaced apart antenna elements arranged in a plurality of rows and columns of the antenna elements and defining a first axis of symmetry. The antenna assembly further includes a non-spherical lens disposed on the phased array antenna and substantially covering at least some of the antenna elements. The non-spherical lens includes a non-spherical first major surface facing away from the antenna elements and an opposing second major surface facing the antenna elements. In a scan plane that includes the first axis of symmetry and a normal to the phased array antenna, the antenna assembly and a comparative antenna assembly have a same construction except that a first major surface of a lens of the comparative antenna assembly is spherical. In the scan plane, the antenna assembly and the comparative antenna assembly steer respective beams in the scan plane having respective maximum gains terminating at respective maximum scan angles S1 and S1′. S1 is greater than S1′ by at least 2 degrees.

In a ninth aspect, the present disclosure provides a lens configured to be disposed on and substantially cover a plurality of spaced apart antenna elements of a phased array antenna. The lens includes a continuous closed annular first band defining a cavity therein extending along a thickness direction of the lens from a first open end of the cavity to an opposite second end. An antenna assembly is formed when the lens is disposed on, and substantially covers, the plurality of spaced apart antenna elements of the phased array antenna with a second major surface disposed between a structured first major surface and the antenna elements. When the antenna assembly is formed, then in a scan plane that includes a first axis of symmetry of the plurality of antenna elements and a normal to the phased array antenna, the antenna assembly and a comparative antenna assembly that has a same construction except that it does not include a lens, steer respective beams in the scan plane having respective maximum gains G_{L} and G_{NL} and respective 3 dB beam widths W_{L} and W_{NL}. For a scan angle of greater than about 15 degrees over a scan angle range of at least 3 degrees, G_{L}>G_{NL} and W_{I}/W_{NL}>0.8.

### BRIEF DESCRIPTION OF THE DRAWINGS

Exemplary embodiments disclosed herein are more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labelled with the same number.

FIG. 1 illustrates a schematic top view of an antenna assembly, according to an embodiment of the present disclosure;

FIG. 2 illustrates a detailed schematic sectional view of the antenna assembly of FIG. 1, according to an embodiment of the present disclosure;

FIG. 3 illustrates a schematic sectional view of a lens of the antenna assembly of FIGS. 1 and 2, according to an embodiment of the present disclosure;

FIGS. 4A to 4C illustrate different views of a lens of the antenna assembly, according to another embodiment of the present disclosure;

FIGS. 5A and 5B illustrate different views of a lens of the antenna assembly, according to another embodiment of the present disclosure;

FIGS. 6A to 6C illustrate different views of a lens of the antenna assembly, according to another embodiment of the present disclosure;

FIGS. 7A to 7C illustrate different views of a lens of the antenna assembly, according to another embodiment of the present disclosure;

FIGS. 8A to 8C illustrate different views of a lens of the antenna assembly, according to another embodiment of the present disclosure;

FIGS. 9A to 9C illustrate different views of a lens of the antenna assembly, according to another embodiment of the present disclosure;

FIGS. 10A to 10C illustrate different views of a lens of the antenna assembly, according to another embodiment of the present disclosure;

FIGS. 11A to 11G illustrate top views of a first annular peak region of a lens of the antenna assembly of FIGS. 1 and 2, according to different embodiments of the present disclosure;

FIG. 12 illustrates a schematic diagram of the antenna assembly of FIG. 2 and the lens of FIG. 3, according to an embodiment of the present disclosure;

FIG. 13 illustrates a schematic sectional view of a lens of a comparative antenna assembly;

FIG. 14 illustrates a graph depicting maximum gain versus scan angle for the antenna assembly of FIG. 12 and the comparative antenna assembly, according to an embodiment of the present disclosure;

FIG. 15 illustrates a graph depicting 3 decibel (dB) beam width versus scan angle for the antenna assembly of FIG. 12 and the comparative antenna assembly, according to an embodiment of the present disclosure;

FIG. 16 illustrates another graph depicting 3 dB beam width versus scan angle for the antenna assembly of FIG. 12 and the comparative antenna assembly, according to an embodiment of the present disclosure;

FIG. 17 illustrates another graph depicting maximum gain versus scan angle for the antenna assembly of FIG. 12 and the comparative antenna assembly, according to an embodiment of the present disclosure;

FIG. 18 illustrates a graph depicting 3 dB beam width versus scan angle for the antenna assembly of FIG. 12 and a comparative antenna assembly, according to an embodiment of the present disclosure;

FIG. 19 illustrates a graph depicting a difference of maximum gain for the antenna assembly of FIG. 12 and maximum gain for a comparative antenna assembly versus scan angle, according to an embodiment of the present disclosure; and

FIG. 20 illustrates a graph depicting a ratio of 3 dB beam width for the antenna assembly of FIGS. 12 and 3 dB beam width for a comparative antenna assembly versus scan angle, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and are without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the term “between about”, unless otherwise specifically defined, generally refers to an inclusive or a closed range. For example, if a parameter X is between about A and B, then A≤X≤B.

As used herein, “gain” of an antenna is a measure of a maximum effectiveness with which the antenna can radiate a unit of power delivered to it by a transmitter towards a target.

As used herein, “antenna boresight” is an axis of maximum antenna gain or maximum radiated power of a directional antenna.

As used herein, “scan angle” represents an angle from an antenna boresight in which the main lobe of the radiation pattern is steered. It can be defined according to a “maximum gain,” “3 dB midpoint,” or other criteria based on the radiation pattern characteristics.

As used herein, “scan range” represents the range of scan angles that can be obtained through appropriate phasing of the antenna array.

As used herein, “loss tangent” quantifies a dielectric material's inherent dissipation of electromagnetic energy. Specifically, the loss tangent is a ratio of resistive and reactive components of a system.

As part of upgrading current mobile network infrastructure to provide 5^{th} Generation (5G) voice and data services, millimeter wave (mmWave) phased array antennas are nowadays being installed on existing Radio Access Network (RAN) cell sites. These cell sites typically support three sector antenna arrays, each of the three sector antenna arrays providing 120 degrees azimuthal coverage within the cell sites. In combination, the three sector antennas provide 360 degrees azimuthal coverage within the cell sites, thereby providing an omnidirectional coverage within the cell sites.

In order to provide a same network coverage within the existing RAN cell sites, highly directive mm Wave antennas are used. The highly directive mmWave antennas include one or a small number of phased arrays and each phased array further includes a large number of radiating elements. However, the highly directive mmWave antennas may limit an azimuthal scan range of an overall antenna assembly due to beam broadening. The beam broadening may occur when the phased arrays broadcast further from an antenna boresight, i.e., at wider azimuthal scan angles. Therefore, the mmWave phased arrays may not provide 120 degrees coverage without a significant gain degradation at the wider azimuthal scan angles. This may lead to a decreased network coverage at seams (i.e., at wider azimuthal scan angles) of the cell sites. Thus, additional cell sites may be required to provide the same network coverage as the existing RAN cell sites.

The present disclosure provides an antenna assembly. The antenna assembly includes a phased array antenna including a plurality of spaced apart antenna elements arranged in a plurality of rows and columns of the antenna elements and defining a first axis of symmetry. The antenna assembly further includes a non-spherical lens disposed on the phased array antenna and substantially covering at least some of the antenna elements. By non-spherical lens, we mean a lens that does not comprise a sphere or any portion of a sphere, such as a hemisphere or other spherical section. The non-spherical lens includes a non-spherical first major surface facing away from the antenna elements and an opposite second major surface facing the antenna elements. The non-spherical first major surface includes at least a curved portion curved along at least one direction. In a scan plane that includes the first axis of symmetry and a normal to the phased array antenna, the antenna assembly steers a beam in the scan plane having a maximum gain G1 and a 3 dB beam width W1 when steered along a first direction making an angle of less than about 10 degrees with the normal and a maximum gain G2 and a 3 dB beam width W2 when steered along a second direction making an angle of no less than about 30 degrees with the normal. G1 and G2 are within 4 dB of each other. Further, W1 and W2 are within 15% of each other.

The 3 dB beam width W1 of the beam steered along the first direction (making the angle of less than about 10 degrees with the normal) and the 3 dB beam width W2 of the beam steered along the second direction (making the angle of equal to or greater than about 30 degrees with the normal) are within 15% of each other. It signifies that the 3 dB beam widths W1, W2 of the beam do not vary more than 15% when steered along two different angles (one angle of less than about 10 degrees with the normal and another angle of equal to or greater than about 30 degrees with the normal). Therefore, the antenna assembly of the present disclosure including the non-spherical lens may limit the beam broadening at the wider azimuthal scan angles (e.g., angles greater than about 30 degrees). In other words, the antenna assembly of the present disclosure including the non-spherical lens may extend the azimuthal scan range, which could be otherwise limited due to the beam broadening. Further, additional cell sites may not be required to provide the same network coverage as the existing RAN cell sites.

Moreover, the maximum gain G1 of the beam steered along the first direction (making the angle of less than about 10 degrees with the normal) and the maximum gain G2 of the beam steered along the second direction (making the angle of equal to or greater than about 30 degrees with the normal) are within 4 dB of each other. It signifies that the maximum gains G1, G2 of the beam do not vary more than 4 dB when steered along two different angles (one angle of less than about 10 degrees with the normal and another angle of equal to or greater than about 30 degrees with the normal). Therefore, the antenna assembly of the present disclosure including the non-spherical lens may limit the beam broadening without the gain degradation at the wider azimuthal scan angles.

Further, in the scan plane that includes the first axis of symmetry and the normal to the phased array antenna, a comparative antenna assembly has a same construction as that of the antenna assembly of the present disclosure except that a first major surface of a lens of the comparative antenna assembly is spherical. In the scan plane, the antenna assembly and the comparative antenna assembly steer respective beams in the scan plane having respective maximum gains terminating at respective maximum scan angles S1 and S1′. S1 is greater than S1′ by at least 2 degrees. As the scan angle S1 at which the maximum gain of the beam steered by the antenna assembly terminates is greater than by at least 2 degrees than the scan angle S1′ at which the maximum gain of the beam steered by the comparative antenna assembly terminates, the antenna assembly of the present disclosure may be operable at greater azimuthal scan angles than the comparative antenna assembly. The non-spherical lens may therefore enable the antenna assembly of the present disclosure to operate at greater azimuthal scan angles.

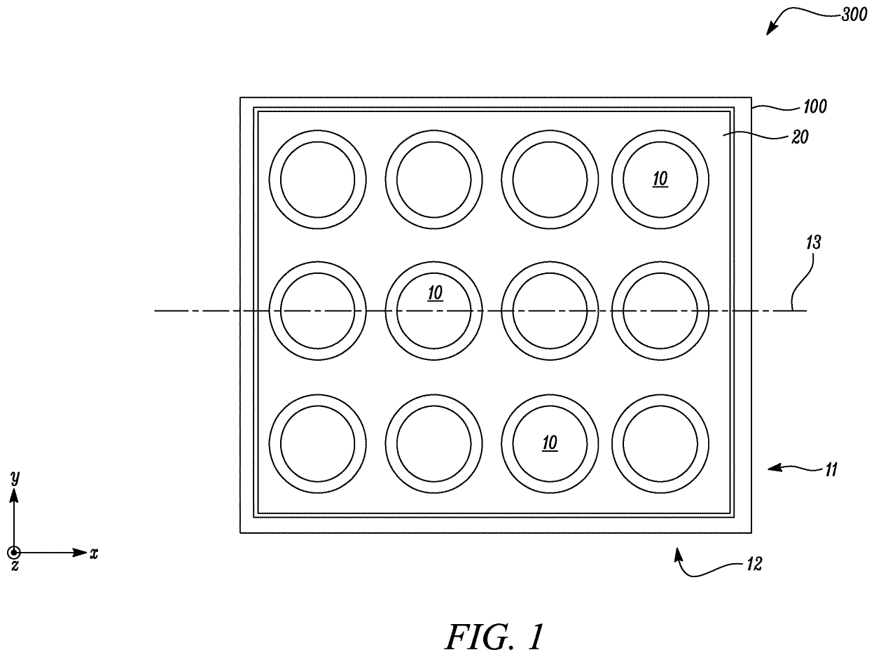

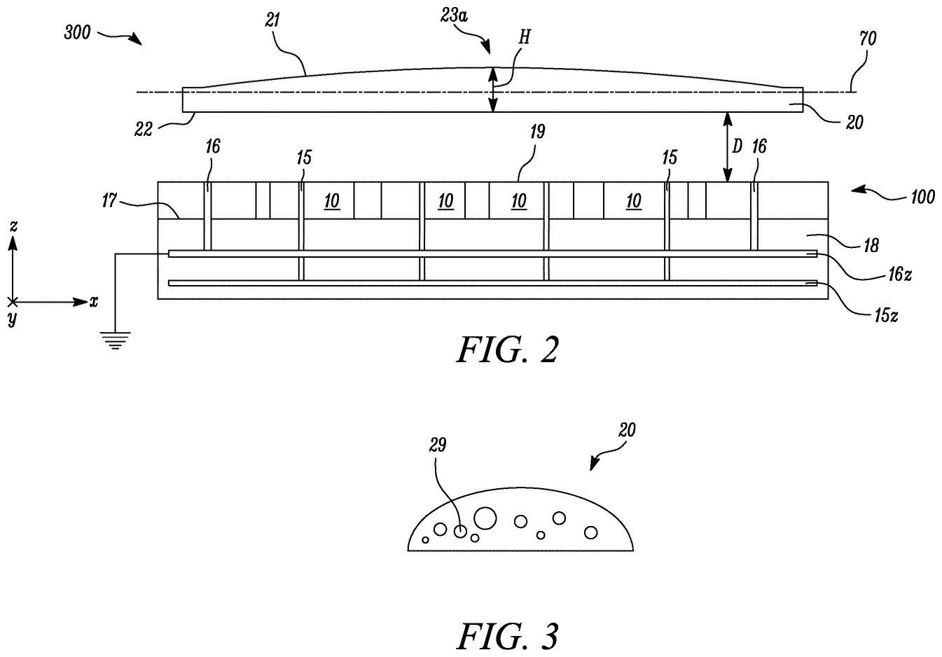

Referring now to figures, FIG. 1 illustrates a schematic top view of an antenna assembly 300, according to an embodiment of the present disclosure. FIG. 2 illustrates a detailed schematic sectional side view of the antenna assembly 300, according to an embodiment of the present disclosure.

Referring to FIGS. 1 and 2, the antenna assembly 300 may have an operational frequency between about 3 Gigahertz (GHz) and 100 GHz. In some embodiments, the operational frequency of the antenna assembly 300 may be one or more of about 3.5 GHz, about 10 GHz, about 24 GHz, about 28 GHz, about 39 GHz, about 60 GHz, and about 95 GHz. The antenna assembly 300 defines mutually orthogonal x, y, and z-axes. The x and y-axes are in-plane axes of the antenna assembly 300, while the Z-axis is a transverse axis disposed along a thickness of the antenna assembly 300. In other words, x and y-axes are along a plane of the antenna assembly 300 defining a x-y plane, and the z-axis is perpendicular to the x-y plane of the antenna assembly 300.

The antenna assembly 300 includes a phased array antenna 100. The phased array antenna 100 includes a two-dimensional array of antenna elements 10. In other words, the phased array antenna 100 includes a plurality of spaced apart antenna elements 10 arranged in a plurality of rows 11 and columns 12 of the antenna elements 10. Specifically, the antenna elements 10 are spaced apart in the x-y plane. The rows 11 extend substantially along the x-axis and the columns 12 extend substantially along the y-axis. The plurality of spaced apart antenna elements 10 defines a first axis of symmetry 13. In the illustrated embodiment of FIG. 1, the phased array antenna 100 includes twelve antenna elements 10. In some embodiments, the plurality of spaced apart antenna elements 10 includes at least 16, at least 64, at least 128, or at least 256 antenna elements 10. However, in some other embodiments, the array may include any number of the antenna elements 10 as per desired application attributes.

In some embodiments, the array of spaced apart antenna elements 10 may include equal number of the rows and columns 11, 12. In other words, the array of spaced apart antenna elements 10 may be a regular array of antenna elements 10. In some embodiments, the regular array of antenna elements 10 may include a regular array of at least sixteen antenna elements 10. In the illustrated embodiment of FIG. 1, the array of spaced apart antenna elements 10 includes four rows 11 and three columns 12 of the antenna elements 10.

The phased array antenna 100 may include one or more feed vias 15 to provide an electrical connection to a corresponding antenna element 10 by an electrical power supply (not shown). Specifically, at high frequencies, the one or more feed vias 15 provide an electrical connection to a corresponding antenna element 10 by an RF signal source. In some embodiments, all the antenna elements 10 are configured to operate at a same power level. In some other embodiments, at least two of the antenna elements 10 are configured to operate at different power levels. In other words, the power supply may be configured to provide electrical power of different magnitudes and phases to at least two of the antenna elements 10.

The phased array antenna 100 may further include one or more ground vias 16 to connect a corresponding antenna element 10 to a common ground (shown in FIG. 2).

In some embodiments, the regular array of the antenna elements 10 is arranged on a surface 17 of a substrate 18. In some embodiments, the surface 17 is substantially planar. In the illustrated embodiment of FIG. 2, the surface 17 is planar and is defined in the x-y plane.

In some embodiments, each of the antenna elements 10 includes a top 19. Specifically, in the illustrated embodiment of FIG. 2, the tops 19 of the antenna elements 10 are substantially planar.

The one or more feed vias 15 may include openings on the surface 17 of the substrate 18. The one or more feed vias 15 may be drilled through the substrate 18 to provide the electrical connection between the corresponding antenna element 10 and the electrical power supply. In some applications, the one or more feed vias 15 may be metal-plated on the substrate 18. The one or more feed vias 15 may include electrical connectors. Each electrical connector may be electrically connected to a bus 15z electrically coupled to the power supply. The bus 15z may be a feed network or a transmission line.

The one or more ground vias 16 may include openings on the surface 17 of the substrate 18. The one or more ground vias 16 may be drilled through the substrate 18. The one or more ground vias 16 may include electrical connectors. Each electrical connector of the ground vias 16 may be electrically connected to a bus 16z that is electrically coupled to the common ground.

The antenna assembly 300 further includes a lens 20 disposed on the phased array antenna 100. In other words, the lens 20 is configured to be disposed on the two-dimensional array of antenna elements 10.

FIG. 3 illustrates a schematic sectional view of the lens 20, according to an embodiment of the present disclosure. In some embodiments, the lens 20 can be interchangeably referred to herein as “the non-spherical lens 20”.

Referring to FIGS. 1 to 3, the lens 20 is configured to be disposed on and substantially cover the plurality of spaced apart antenna elements 10 of the phased array antenna 100. In some embodiments, the non-spherical lens 20 is disposed on the phased array antenna 100 and substantially cover at least some of the antenna elements 10.

In some embodiments, the non-spherical lens 20 substantially covers at least 20% of the antenna elements 10. In some embodiments, the non-spherical lens 20 substantially covers at least 30%, at least 40%, at least 50%, at least 60%, at least 70%, at least 80%, or at least 90% of the antenna elements 10. In some embodiments, the plurality of spaced apart antenna elements 10 includes at least 64 antenna elements and the non-spherical lens 20 substantially covers at least 16 of the antenna elements 10. In some embodiments, the plurality of spaced apart antenna elements 10 includes at least 64 antenna elements and the non-spherical lens 20 substantially covers at least 32 of the antenna elements 10. In some embodiments, the non-spherical lens 20 substantially covers all of the antenna elements 10. In some embodiments, the non-spherical lens 20 is a solid lens (e.g., as shown in FIG. 2). In some embodiments, the non-spherical lens 20 includes a plurality of voids 29. The plurality of voids 29 may direct any heat generated by the antenna assembly 300 away from the antenna elements 10. The plurality of voids 29 may be introduced into the lens 20 during fabrication of the lens 20. In the illustrated embodiment of FIG. 3, the voids 29 are substantially spherical voids.

In some embodiments, at a frequency of about 28 GHz, the non-spherical lens 20 has a dielectric permittivity of between about 1.2 and about 2. In some embodiments, at the frequency of about 28 GHz, the non-spherical lens 20 has the dielectric permittivity of between about 1.3 and about 1.8, between about 1.4 and about 1.6, or between about 1.4 and about 1.55.

In some embodiments, at the frequency of about 28 GHz, the non-spherical lens 20 has a loss tangent of between about 0.001 and about 0.005. In some embodiments, at the frequency of about 28 GHz, the non-spherical lens 20 has the loss tangent of between about 0.002 and about 0.004, or between about 0.0025 and about 0.004.

The lens 20 includes a structured first major surface 21 opposite a second major surface 22. In some embodiments, the structured first major surface 21 can be interchangeably referred to herein as “the non-spherical first major surface 21”. Specifically, the non-spherical lens 20 includes the non-spherical first major surface 21 facing away from the antenna elements 10 and the opposite second major surface 22 facing the antenna elements 10. In other words, the non-spherical lens 20 includes the non-spherical first major surface 21 and the opposing second major surface 22. It can be stated that the antenna assembly 300 is formed when the lens 20 is disposed on, and substantially covers, the plurality of spaced apart antenna elements 10 of the phased array antenna 100.

The non-spherical first major surface 21 includes at least a curved portion curved along at least one direction. In some embodiments, the second major surface 22 of the non-spherical lens 20 is substantially planar. In some embodiments, the second major surface 22 of the lens 20 and the antenna elements 10 define a non-zero minimum gap D therebetween. In some embodiments, the minimum gap D is between about ⅛ to about ½ of a free-space wavelength of an operating frequency of the antenna assembly 300. In some embodiments, the minimum gap D may be between about 1.5 mm to about 5 mm. In some embodiments, the minimum gap D may be about 1.75 mm to about 4.5 mm or about 2 mm to about 4 mm.

In some embodiments, the lens 20 has a height H. The height H may be substantially along the Z-axis. The height H may correspond to a maximum distance between the structured first major surface 21 and the second major surface 22. In some embodiments, the height H of the lens 20 is from about 1.1 times to about 3.4 times an effective wavelength in the lens 20, wherein the effective wavelength is the free-space wavelength divided by square root of the relative permittivity.

In some embodiments, the height H of the lens 20 is greater than or equal to about 10 mm and less than or equal to about 30 mm, i.e., 10 mm≤H≤30 mm. In some embodiments, 15 mm≤H≤25 mm, or 20 mm≤H≤25 mm. However, the height H of the lens 20 may be any height as per desired application attributes.

The structured first and second major surfaces 21, 22 define a reference plane 70 disposed inclusive therebetween and closest to the structured first major surface 21. Further, the structured first major surface 21 includes a center 23a.

The antenna assembly 300 may include different types of the non-spherical lenses 20 having different shapes and characteristics (e.g., electromagnetic characteristics) based on desired application attributes, for example, a desired performance. The non-spherical lenses 20 may be designed using automated tools to obtain a particular shape which may be difficult to design manually. The different types of the non-spherical lenses 20 are discussed in detail below.

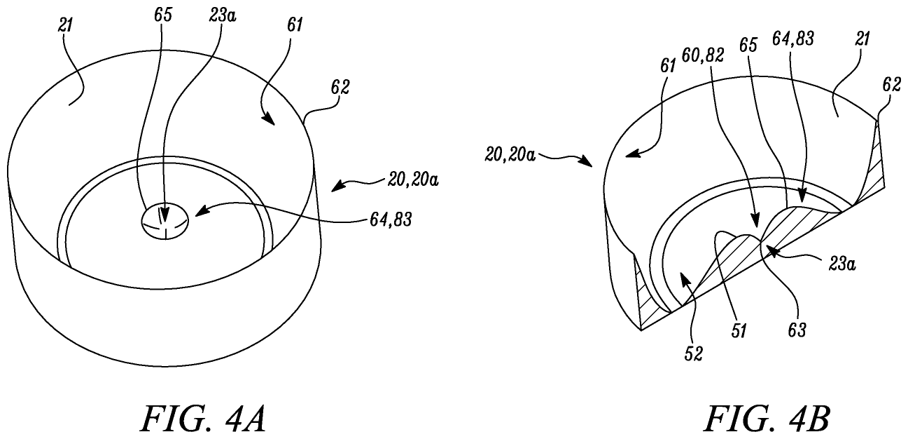

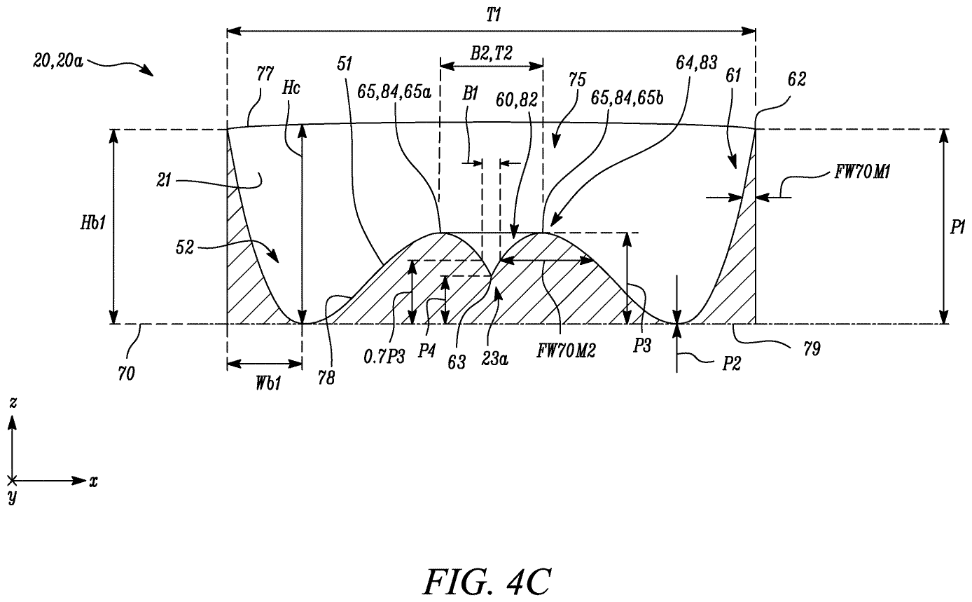

FIGS. 4A to 4C illustrate different views of a lens 20a (a type of the non-spherical lens 20 shown in FIG. 2) of the antenna assembly 300 (shown in FIG. 2), according to an embodiment of the present disclosure. Specifically, FIG. 4A illustrates a perspective view of the lens 20a, FIG. 4B illustrates a perspective sectional view of the lens 20a, and FIG. 4C illustrates a schematic sectional side view of the lens 20a.

Referring to FIGS. 4A to 4C, the structured first major surface 21 includes a first annular peak region 61 surrounding, and substantially concentric with, the center 23a. In some embodiments, the first annular peak region 61 can be interchangeably referred to herein as “the continuous closed annular first band 61”. In other words, the lens 20a (i.e., the lens 20) includes the continuous closed annular first band 61. The first annular peak region 61 has a first annular peak 62. In some embodiments, the first annular peak 62 can be interchangeably referred to herein as “the continuous closed annular first band peak 62”. In other words, the continuous closed annular first band 61 includes a corresponding continuous closed annular first band peak 62. In the illustrated embodiment of FIGS. 4A to 4C, the continuous closed annular first band 61 is substantially rotationally symmetric about the center 23a of the lens 20a.

As is shown in FIG. 4C, the first annular peak 62 has an average separation P1 from the reference plane 70. A minimum separation between the structured first major surface 21 and the reference plane 70 inside the first annular peak 62 is P2, such that P1/P2≥2. In some embodiments, P1/P2≥3, P1/P2≥4, P1/P2≥5, P1/P2≥10, P1/P2≥15, P1/P2≥20, P1/P2≥30, P1/P2≥40, P1/P2≥50, P1/P2≥100, P1/P2≥150, P1/P2≥200, P1/P2≥300, P1/P2≥400, or P1/P2≥500.

Further, relative to the reference plane 70, the first annular peak region 61 has an annular full width at 70% maximum FW70M1. In the illustrated embodiment of FIGS. 4A to 4C, FW70M1/P1≤0.5.

In the illustrated embodiment of FIGS. 4A to 4C, the annular first band 61 defines a cavity 75 therein extending along a thickness direction of the lens 20a. The thickness direction may be substantially along the z-axis. Specifically, the cavity 75 extends from a first open end 77 of the cavity 75 at the first band peak 62 to an opposite second end 78. The cavity 75 has a maximum height Hc along the thickness direction of the lens 20a. The first band 61 has a height Hb1 along the thickness direction of the lens 20a. Further, the first band 61 has a base 79 having a width Wb1. In the illustrated embodiment of FIGS. 4A to 4C, Hc/Hb1≥0.5. Further, in the illustrated embodiment of FIGS. 4A to 4C, Hb1>Wb1.

In some embodiments, the lens 20a further includes a protrusion 51 near or at the center 23a of the second end 78 and protruding toward the first open end 77. The protrusion 51 and the continuous closed annular first band 61 define a continuous closed annular first channel 52 substantially co-extensive and concentric with the continuous closed annular first band 61. In the illustrated embodiment of FIGS. 4A to 4C, the lens 20a further includes the protrusion 51 near the center 23a of the second end 78 and protruding toward the first open end 77.

Further, the structured first major surface 21 includes a central cusp region 60 at or near the center 23a having an apex 63. The lens 20a further defines a central cavity 82 at or near the center 23a of the lens 20a. In the illustrated embodiment of FIGS. 4A to 4C, the central cusp region 60 defines the central cavity 82. The structured first major surface 21 further includes a second annular peak region 64 disposed between the center 23a and the first annular peak region 61. The second annular peak region 64 surrounds, and is substantially concentric with, the center 23a. The second annular peak region 64 includes a second annular peak 65. Further, the second annular peak 65 has an average separation P3 from the reference plane 70. In the illustrated embodiment of FIGS. 4A to 4C, P3<P1.

The cavity 82 is surrounded by a continuous closed annular peak region 83 having a continuous closed annulus peak 84. In the illustrated embodiment of FIGS. 4A to 4C, the continuous closed annular peak region 83 is equivalent to the second annular peak region 64. Further, the continuous closed annulus peak 84 is equivalent to the second annular peak 65. The lens 20a and the annulus peak 84 have respective maximum lateral dimensions T1 and T2. In the illustrated embodiment of FIGS. 4A to 4C, T2/T1≤0.8.

The apex 63 of the central cusp region 60 is spaced a distance P4 from the reference plane 70. In the illustrated embodiment of FIGS. 4A to 4C, P4<P3. Further, relative to the reference plane 70, the second annular peak region 64 has an annular full width at 70% maximum FW70M2. In other words, relative to the reference plane 70, the first and second annular peak regions 61, 64 have respective annular full widths at 70% maximum FW70M1 and FW70M2. In the illustrated embodiment of FIGS. 4A to 4C, FW70M2>FW70M1.

Further, in some embodiments, at a distance of about 0.7P3 from the reference plane 70, the central cusp region 60 has a maximum full width B1. The second annular peak 65 has a maximum lateral width B2. In the illustrated embodiment of FIGS. 4A to 4C, B1/B2≤0.5. In some embodiments, B1/B2≤0.4, B1/B2≤0.3, B1/B2≤0.2, or B1/B2≤0.1.

Furthermore, in at least a first planar cross-section (i.e., x-z plane) that is substantially parallel to the thickness direction (i.e., along the z-axis) of the lens 20a and includes the apex 63, the structured first major surface 21 includes the cusp region 60 and the apex 63 of the cusp region 60 disposed between first and second peaks 65a, 65b. The first and second peaks 65a, 65b are part of the second annular peak 65 and are shown as two separate peaks in the first planar cross-section (i.e., x-z plane). In the illustrated embodiment of FIGS. 4A to 4C, a slope of the structured first major surface 21 changes sign across the cusp region 60.

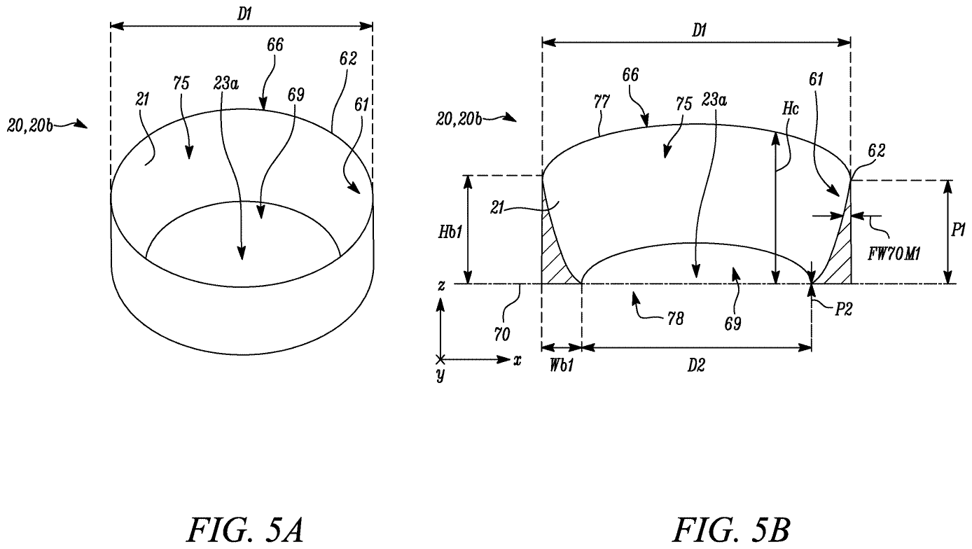

FIGS. 5A and 5B illustrate different views of a lens 20b (another type of the non-spherical lens 20) of the antenna assembly 300 (shown in FIG. 2), according to an embodiment of the present disclosure. Specifically, FIG. 5A illustrates a perspective view of the lens 20b and FIG. 5B illustrates a schematic sectional view of the lens 20b.

The lens 20b is substantially similar and functionally equivalent to the lens 20a of FIGS. 4A to 4C, with common components being referred to by the same reference numerals. However, the lens 20b does not include a central cusp region (i.e., the cusp region 60 shown in FIG. 4C), a second annular peak region (i.e., the second annular peak region 64 shown in FIG. 4C), and a protrusion (i.e., the protrusion 51 shown in FIG. 4C) near or at the center 23a of the second end 78 or the lens 20b. In other words, the lens 20b does not include a central cavity (i.e., the central cavity 82 shown in FIG. 4C). Further, in the illustrated embodiment of FIGS. 5A and 5B, the second end 78 is open.

Further, in the illustrated embodiment of FIGS. 5A and 5B, FW70M1/P1≤0.5. Further, the first annular peak region 61 defines a central hollow annular portion of the lens 20b extending along the thickness direction (i.e., along the z-axis) from a first open end 66 at the first annular peak 62 to an opposite second open end 69 at the second major surface 22 (shown in FIG. 2). The first and second ends 66, 69 have respective maximum lateral dimensions D1 and D2. In the illustrated embodiment of FIGS. 5A and 5B, 0.5<D2/D1<1.

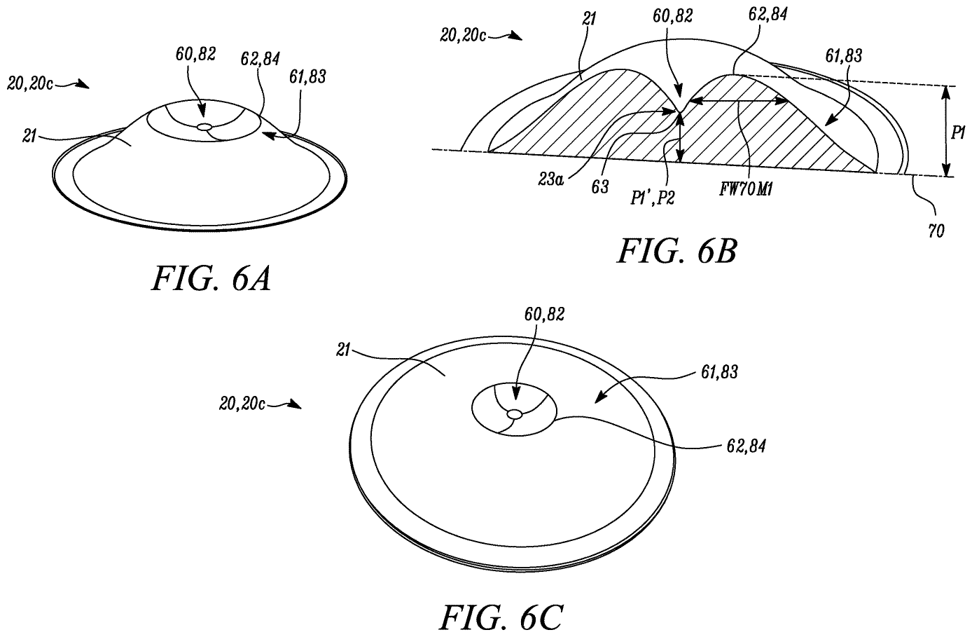

FIGS. 6A to 6C illustrate different views of a lens 20c (another type of the non-spherical lens 20) of the antenna assembly 300 (shown in FIG. 2), according to an embodiment of the present disclosure. Specifically, FIG. 6A illustrates a side perspective view of the lens 20c, FIG. 6B illustrates a schematic sectional view of the lens 20c, and FIG. 6C illustrates a top perspective view of the lens 20c.

The lens 20c is substantially similar and functionally equivalent to the lens 20a of FIGS. 4A to 4C, with common components being referred to by the same reference numerals. However, the lens 20c does not include a second annular peak region (i.e., the second annular peak region 64 shown in FIG. 4C), a cavity (i.e., the cavity 75 shown in FIG. 4C), and a protrusion (i.e., the protrusion 51 shown in FIG. 4C). Therefore, in the lens 20c, the first annular peak region 61 surrounds the apex 63.

In the illustrated embodiment of FIGS. 6A to 6C, the continuous closed annular peak region 83 is equivalent to the first annular peak region 61. The continuous closed annulus peak 84 is equivalent to the first annular peak 62. In the illustrated embodiment of FIGS. 6A to 6C, FW70M1/P1≥0.5. The apex 63 of the central cusp region 60 is spaced a distance P1′ from the reference plane 70. In the illustrated embodiment of FIGS. 6A to 6C, P1′<P1.

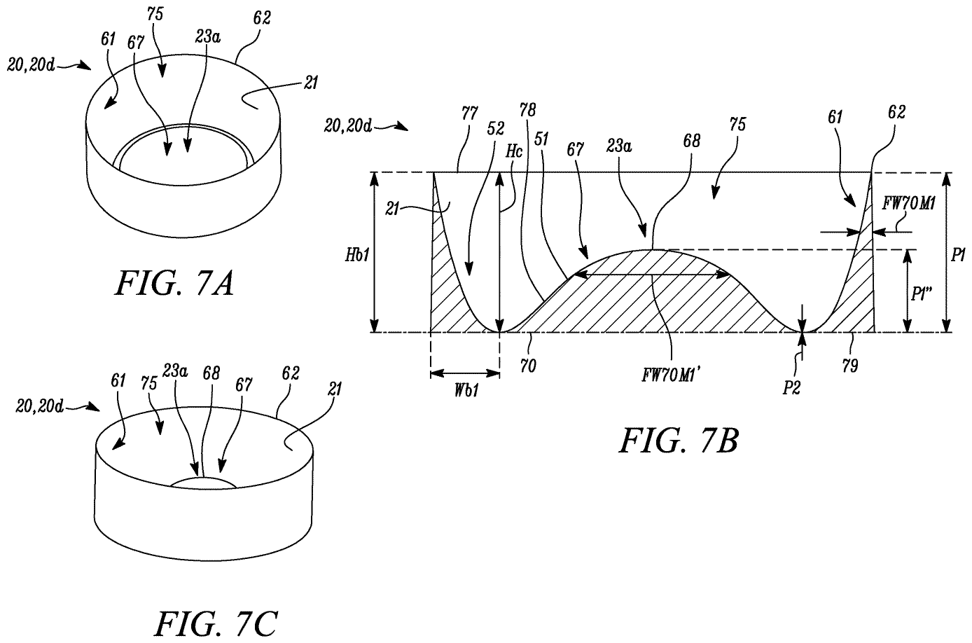

FIGS. 7A to 7C illustrate different views of a lens 20d (another type of the non-spherical lens 20) of the antenna assembly 300 (shown in FIG. 2), according to an embodiment of the present disclosure. Specifically, FIG. 7A illustrates a top perspective view of the lens 20d, FIG. 7B illustrates a schematic side sectional view of the lens 20d. FIG. 7C illustrates a side perspective view of the lens 20d.

The lens 20d is substantially similar and functionally equivalent to the lens 20a of FIGS. 4A to 4C, with common components being referred to by the same reference numerals. However, the lens 20d does not include a central cusp region (i.e., the central cusp region 60 shown in FIG. 4C), a second annular peak region (i.e., the second annular peak region 64 shown in FIG. 4C), and a cavity (i.e., the central cavity 82 shown in FIG. 4C).

Further, in the lens 20d, the structured first major surface 21 includes a central convex peak region 67 at or near the center 23a having a peak 68. The first annular peak region 61 surrounds the peak 68. The peak 68 of the central convex peak region 67 is spaced a distance P1″ from the reference plane 70. In the illustrated embodiment of FIGS. 7A to 7C, P1″<P1. Moreover, in the lens 20d, relative to the reference plane 70, the first annular peak region 61 and the central convex peak region 67 have respective annular full widths at 70% maximum FW70M1 and FW70M1′. In the illustrated embodiment of FIGS. 7A to 7C, FW70M1′>FW70M1.

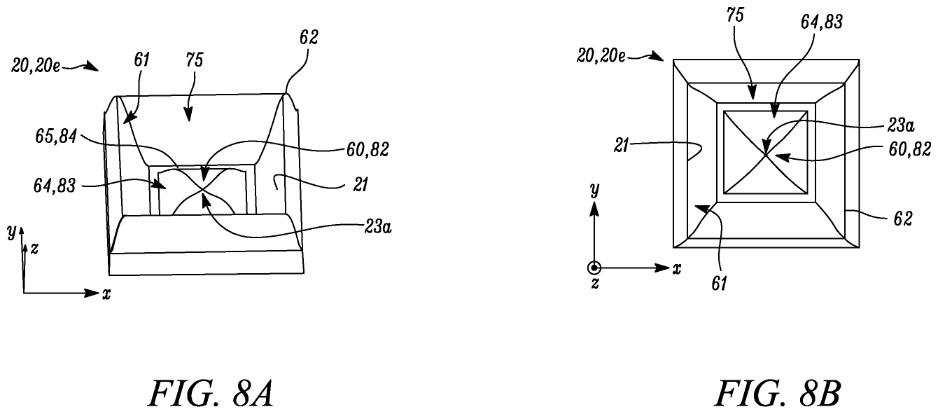

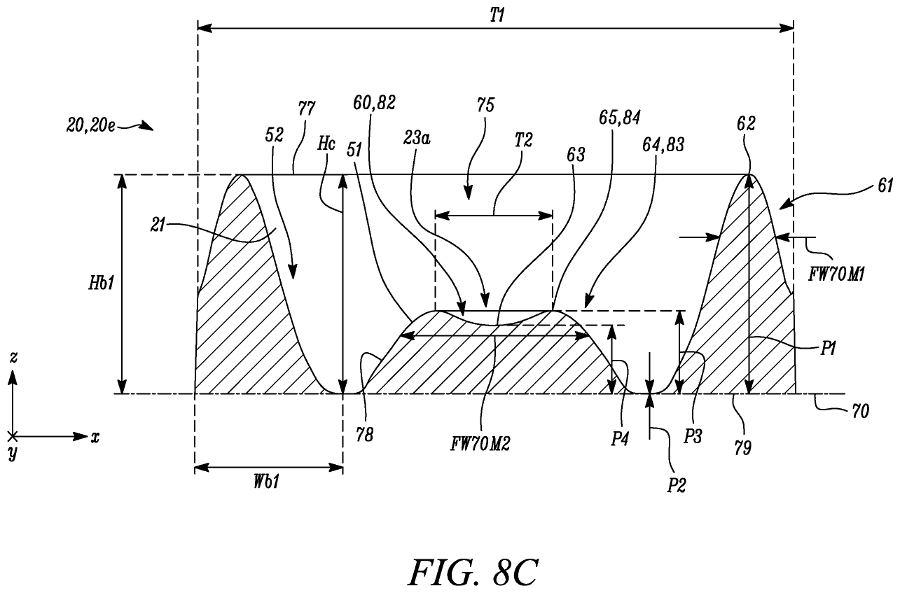

FIGS. 8A to 8C illustrate different views of a lens 20e (another type of the non-spherical lens 20) of the antenna assembly 300 (shown in FIG. 2), according to an embodiment of the present disclosure. Specifically, FIG. 8A illustrates a perspective top view of the lens 20e, FIG. 8B illustrates a top view of the lens 20e, and FIG. 8C illustrates a schematic side sectional view of the lens 20e.

The lens 20e is substantially similar and functionally equivalent to the lens 20a of FIGS. 4A to 4C, with common components being referred to by the same reference numerals. However, the central cusp region 60 of the lens 20e is slightly different in shape as compared to the central cusp region 60 of the lens 20a of FIG. 4C. In the illustrated embodiment of FIGS. 8A to 8C, FW70M1/P1≤1. Further, P3<P1, and 0.5≤P4/P3<1.

In the lens 20e, the continuous closed annular first band 61 has a substantially polygonal shape (instead of substantially rotationally symmetric). In some embodiments, the substantially polygonal shape is a substantially square shape. In some embodiments, the substantially polygonal shape is a substantially rectangular shape.

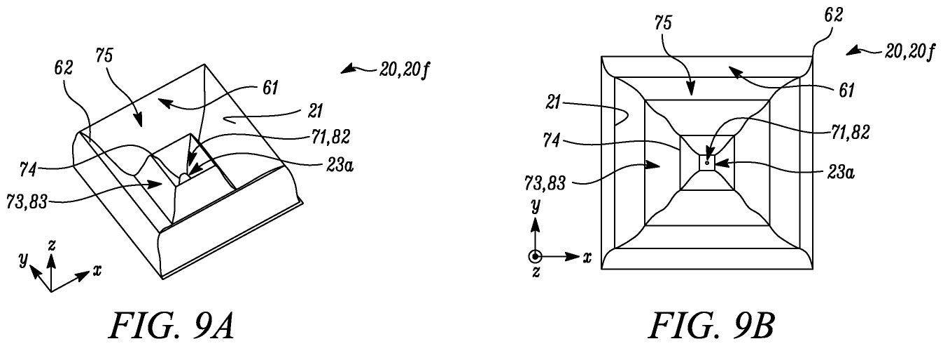

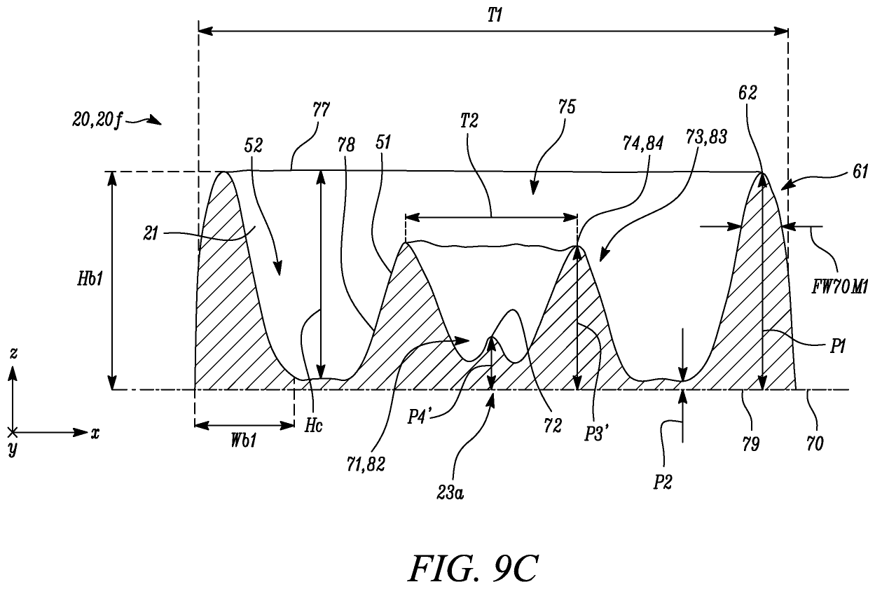

FIGS. 9A to 9C illustrate different views of a lens 20f (another type of the non-spherical lens 20) of the antenna assembly 300 (shown in FIG. 2), according to an embodiment of the present disclosure. Specifically, FIG. 9A illustrates a perspective top view of the lens 20f, FIG. 9B illustrates a top view of the lens 20f, and FIG. 9C illustrates a schematic side sectional view of the lens 20f.

The lens 20f is substantially similar and functionally equivalent to the lens 20a of FIGS. 4A to 4C, with common components being referred to by the same reference numerals. However, in the lens 20f, FW70M1/P1≤0.7.

Further, in the lens 20f, the structured first major surface 21 includes a central convex peak region 71 (instead of the cusp region 60 shown in FIG. 4C) at or near the center 23a having a peak 72. The structured first major surface 21 further includes a second annular peak region 73 (instead of the second annular peak region 64 shown in FIG. 4C) disposed between the central convex peak region 71 and the first annular peak region 61. The second annular peak region 73 surrounds, and is substantially concentric with, the center 23a. The second annular peak region 73 includes a second annular peak 74 (instead of the second annular peak 65 shown in FIG. 4C) having an average separation P3′ from the reference plane 70. In the illustrated embodiment of FIGS. 9A to 9C, 0.5≤P3′/P1≤1. In the illustrated embodiment of FIGS. 9A to 9C, the continuous closed annular peak region 83 is equivalent to the second annular peak region 73. Further, the continuous closed annulus peak 84 is equivalent to the second annular peak 74. The central convex peak region 71 defines the central cavity 82. Furthermore, the peak 72 of the central convex peak region 71 is spaced a distance P4′ from the reference plane 70. In the illustrated embodiment of FIGS. 9A to 9C, P4′<P3′.

In the lens 20f, the continuous closed annular first band 61 has a substantially polygonal shape (instead of substantially rotationally symmetric). In some embodiments, the substantially polygonal shape is a substantially square shape. In some embodiments, the substantially polygonal shape is a substantially rectangular shape. Further, the second annular peak region 73 has a substantially polygonal shape.

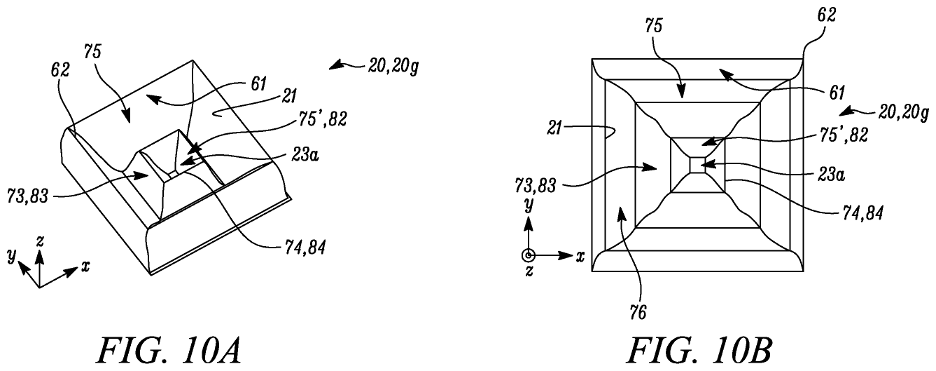

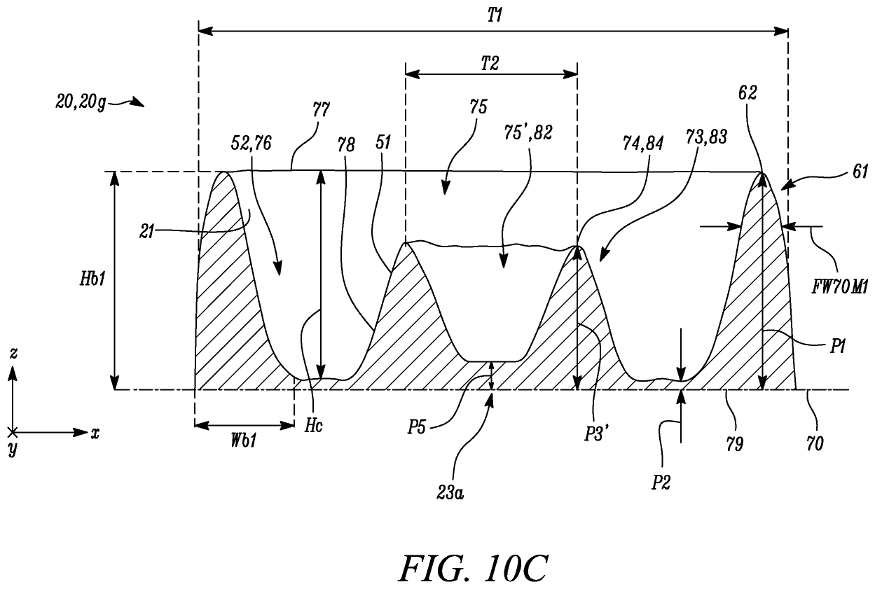

FIGS. 10A to 10C illustrate different views of a lens 20g (another type of the non-spherical lens 20) of the antenna assembly 300 (shown in FIG. 2), according to an embodiment of the present disclosure. Specifically, FIG. 10A illustrates a perspective top view of the lens 20g, FIG. 10B illustrates a top view of the lens 20g, and FIG. 10C illustrates a schematic side sectional view of the lens 20g.

The lens 20g is substantially similar and functionally equivalent to the lens 20f of FIGS. 9A to 9C, with common components being referred to by the same reference numerals. However, the lens 20g does not include a central convex peak region (i.e., the central convex peak region 71 and the peak 72).

In the lens 20g, the second annular peak region 73 defines a cavity 75′ therein. The second annular peak region 73 is disposed within, and substantially co-extensive and concentric, with the first annular peak region 61. In the illustrated embodiment of FIGS. 10A to 10C, P3′<P1. Further, a minimum separation between the structured first major surface 21 and the reference plane 70 inside the cavity 75′ is P5. In the illustrated embodiment of FIGS. 10A to 10C, P5<P3′. Further, FW70M1/P1≤0.7.

The first and second annular peak regions 61, 73 define an annular cavity 76 therein. The annular cavity 76 is substantially co-extensive and concentric with the first and second annular peak regions 61, 73. Therefore, a minimum separation between the structured first major surface 21 and the reference plane 70 inside the annular cavity 76 is P2. In the illustrated embodiment of FIGS. 10A to 10C, the continuous closed annular peak region 83 is equivalent to the second annular peak region 73. The continuous closed annulus peak 84 is equivalent to the second annular peak 74. The central cavity 82 is equivalent to the cavity 75′.

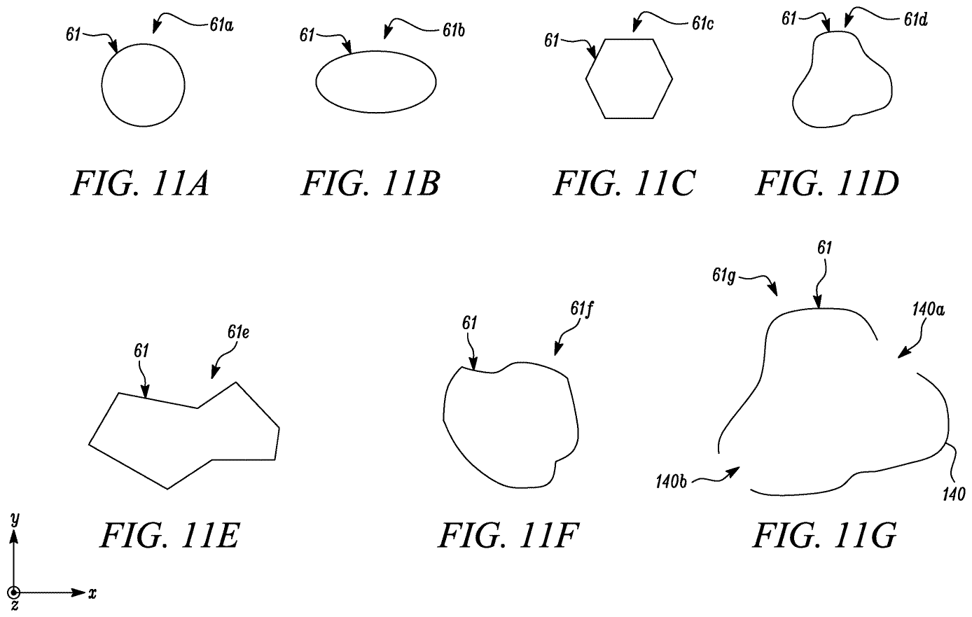

FIG. 11A illustrates a top view of the first annular peak region 61 of the lens 20 (shown in FIGS. 1 and 2) of the antenna assembly 300, according to an embodiment of the present disclosure. In the illustrated embodiment of FIG. 11A, the first annular peak region 61 has a circular shape 61a.

FIG. 11B illustrates a top view of the first annular peak region 61 of the lens 20 (shown in FIGS. 1 and 2) of the antenna assembly 300, according to another embodiment of the present disclosure. In the illustrated embodiment of FIG. 11B, the first annular peak region 61 has an oval shape 61b.

FIG. 11C illustrates a top view of the first annular peak region 61 of the lens 20 (shown in FIGS. 1 and 2) of the antenna assembly 300, according to another embodiment of the present disclosure. In the illustrated embodiment of FIG. 11C, the first annular peak region 61 has a polygonal shape 61c.

FIG. 11D illustrates a top view of the first annular peak region 61 of the lens 20 (shown in FIGS. 1 and 2) of the antenna assembly 300, according to another embodiment of the present disclosure. In the illustrated embodiment of FIG. 11D, the first annular peak region 61 has a curvilinear shape 61d.

FIG. 11E illustrates a top view of the first annular peak region 61 of the lens 20 (shown in FIGS. 1 and 2) of the antenna assembly 300, according to another embodiment of the present disclosure. In the illustrated embodiment of FIG. 11E, the first annular peak region 61 has a piecewise linear shape 61e.

FIG. 11F illustrates a top view of the first annular peak region 61 of the lens 20 (shown in FIGS. 1 and 2) of the antenna assembly 300, according to another embodiment of the present disclosure. In the illustrated embodiment of FIG. 11F, the first annular peak region 61 has a piecewise curved shape 61f.

In some embodiments, the first annular peak region 61 is a closed annulus having a continuous circumference.

FIG. 11G illustrates a top view of the first annular peak region 61 of the lens 20 (shown in FIGS. 1 and 2) of the antenna assembly 300, according to another embodiment of the present disclosure. In the illustrated embodiment of FIG. 11G, the first annular peak region 61 is an open annulus 61g having a circumference 140 including one or more discontinuities 140a, 140b having a total length of less than about 30% of a total length of the circumference 140 of the first annular peak region 61. In some embodiments, the total length of the one or more discontinuities 140a, 140b is less than about 25%, about 20%, about 15%, about 10%, or about 5% of a total length of the circumference 140 of the first annular peak region 61.

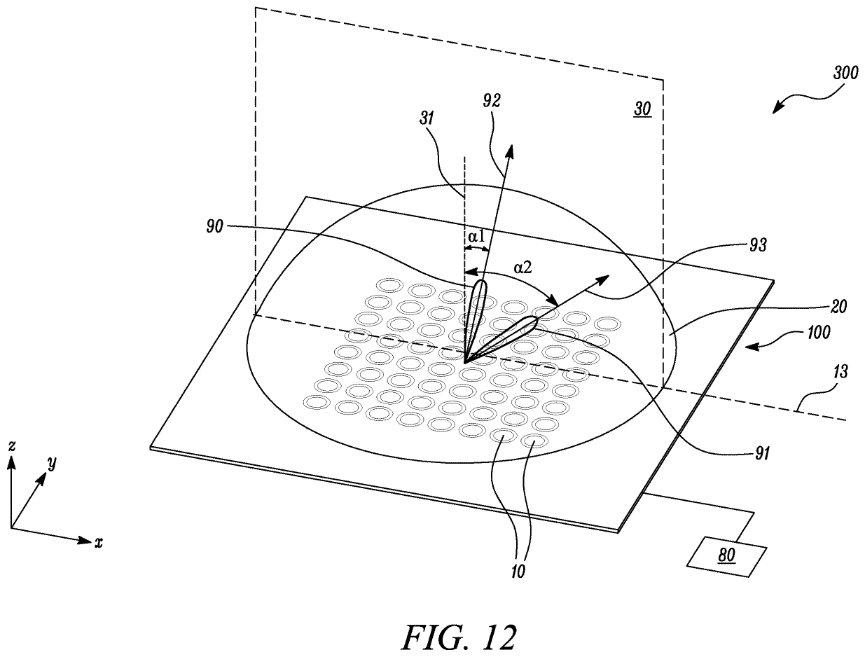

FIG. 12 illustrates a schematic diagram of the antenna assembly 300 including the lens 20, according to an embodiment of the present disclosure. The lens 20 can be any one of the lenses 20a, 20b, 20c, 20d, 20e, 20f, 20g of respective FIGS. 4A, 5A, 6A, 7A, 8A, 9A, and 10A.

In the illustrated embodiment of FIG. 12, the array of spaced apart antenna elements 10 is the regular array including sixty-four antenna elements 10 arranged along the rows 11 (shown in FIG. 1) and the columns 12 (shown in FIG. 1). In some embodiments, the antenna system 300 further includes a control apparatus 80 coupled to and energizing the antenna elements 10. The antenna assembly 300 further includes a scan plane 30 that includes the first axis of symmetry 13 of the plurality of the antenna elements 10 and a normal 31 (i.e., along the z-axis) to the phased array antenna 100.

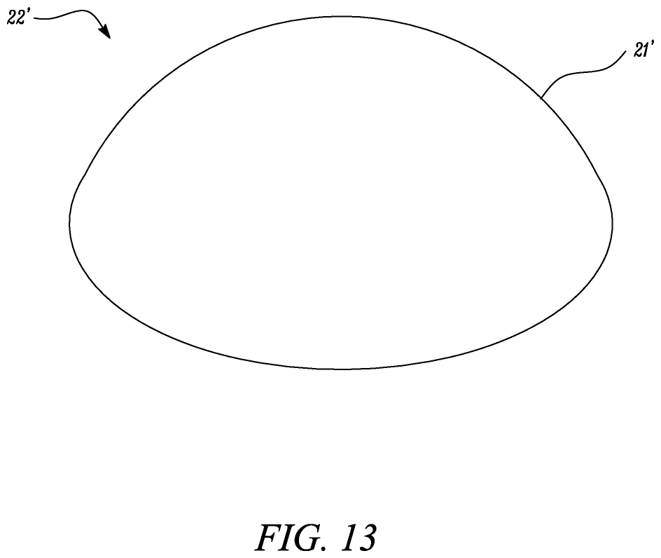

FIG. 13 illustrates a schematic perspective view of a lens 22′ of a comparative antenna assembly (not shown). With reference to FIGS. 12 and 13, the antenna assembly 300 (shown in FIGS. 2 and 12) and the comparative antenna assembly have a same construction, except that a first major surface 21′ of the lens 22′ of the comparative antenna assembly is spherical.

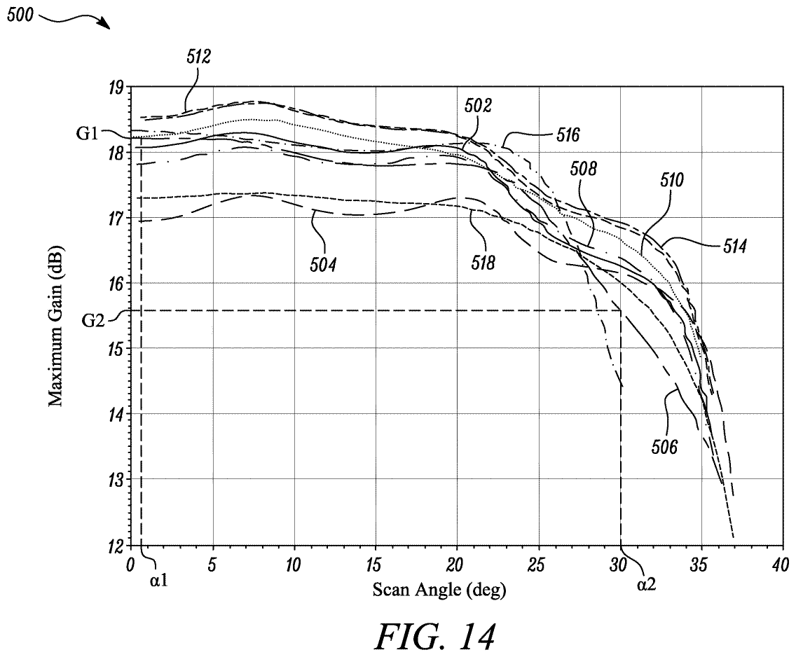

FIG. 14 illustrates a graph 500 depicting maximum gain versus scan angle for the antenna assembly 300 of FIGS. 2 and 12 and the comparative antenna assembly, according to an embodiment of the present disclosure. The scan angle is expressed in degrees (deg) in the abscissa. The maximum gain is expressed in decibels (dB) in the ordinate.

The graph 500 includes curves 502, 504, 506, 508, 510, 512, 514, 516, and 518. The curve 502 depicts maximum gain versus scan angle for the antenna assembly 300 including the lens 20a (shown in FIGS. 4A to 4C). The curve 504 depicts maximum gain versus scan angle for the antenna assembly 300 including the lens 20b (shown in FIGS. 5A and 5B). The curve 506 depicts maximum gain versus scan angle for the antenna assembly 300 including the lens 20c (shown in FIGS. 6A to 6C). The curve 508 depicts maximum gain versus scan angle for the antenna assembly 300 including the lens 20d (shown in FIGS. 7A to 7C). The curve 510 depicts maximum gain versus scan angle for the antenna assembly 300 including the lens 20e (shown in FIGS. 8A to 8C). The curve 512 depicts maximum gain versus scan angle for the antenna assembly 300 including the lens 20f (shown in FIGS. 9A to 9C). The curve 514 depicts maximum gain versus scan angle for the antenna assembly 300 including the lens 20g (shown in FIGS. 10A to 10C). The curve 516 depicts maximum gain versus scan angle for the comparative antenna assembly including the lens 22′ (shown in FIG. 13). The curve 518 depicts maximum gain versus scan angle for an antenna assembly having a same construction as that of the antenna assembly 300 (shown in FIG. 2) except that it does not include any lens. In other words, the curve 518 depicts the maximum gain versus scan angle for the phased array antenna 100 (shown in FIG. 2).

Referring to FIGS. 2, 12, 13, and 14, when the lens 20 is disposed on and substantially covers the plurality of spaced apart antenna elements 10 of the phased array antenna 100 with the second major surface 22 disposed between the structured first major surface 21 and the antenna elements 10, then in the scan plane 30, the antenna elements 10 steer a beam 90 in the scan plane 30 having a maximum gain G1 when steered along a first direction 92 (interchangeably referred to herein as the scan direction 92) making an angle α1 of less than about 10 degrees with the normal 31. In other words, in the scan plane 30, the antenna assembly 300 steers the beam 90 having the maximum gain G1 when steered along the first direction 92 making the angle α1 of less than about 10 degrees with the normal 31. For illustrative purposes, G1 is labelled only for the antenna assembly 300 including the lens 20c of FIGS. 6A to 6C (depicted by the curve 506). In the graph 500, the angle α1 is about 0.8 degrees and G1 is about 18.2 dB.

Further, when the lens 20 is disposed on and substantially covers the plurality of spaced apart antenna elements 10 of the phased array antenna 100 with the second major surface 22 disposed between the structured first major surface 21 and the antenna elements 10, then in the scan plane 30, the antenna elements 10 steer a beam 91 in the scan plane 30 having a maximum gain G2 when steered along a second direction 93 making an angle α2 of no less than about 30 degrees with the normal 31. In other words, in the scan plane 30, the antenna assembly 300 steers the beam 91 having the maximum gain G2 when steered along the second direction 93 making the angle α2 of no less than about 30 degrees with the normal 31. For illustrative purposes, G2 is labelled only for the antenna assembly 300 including the lens 20c of FIGS. 6A to 6C (depicted by the curve 506). In the graph 500, the angle α2 is about 30 degrees, and G2 is about 15.6 dB. As is apparent from the curve 506, G1 and G2 are within 4 dB of each other.

For other curves 502, 504, 508, 510, 512, and 514, G1 and G2 are not labelled. However, from the curve 502, it is apparent that G1 and G2 are within 2 dB of each other. Further, from the curve 504, it is apparent that G1 and G2 are within 1 dB of each other. From the curve 508, it is apparent that G1 and G2 are within 2 dB of each other. Therefore, in some embodiments, G1 and G2 are within 3.5 dB, within 3 dB, within 2.5 dB, within 2 dB, within 1.5 dB, within 1 dB, or within 0.5 dB of each other. It signifies that the maximum gains G1, G2 of the respective beams 90, 91 do not vary more than 4 dB when steered along the respective angles α1, α2 (α1 is less than about 10 degrees with the normal and α2 is equal to or greater than about 30 degrees with the normal 31). Further, while comparing the curve 516 with the curves 502, 504, 506, 508, 510, 512, and 514, it is apparent that for a beam steered along a direction making a scan angle of greater than about 25 degrees, the antenna assembly 300 including the lens 20 steers that beam with a relatively higher maximum gain as compared to the comparative antenna assembly.

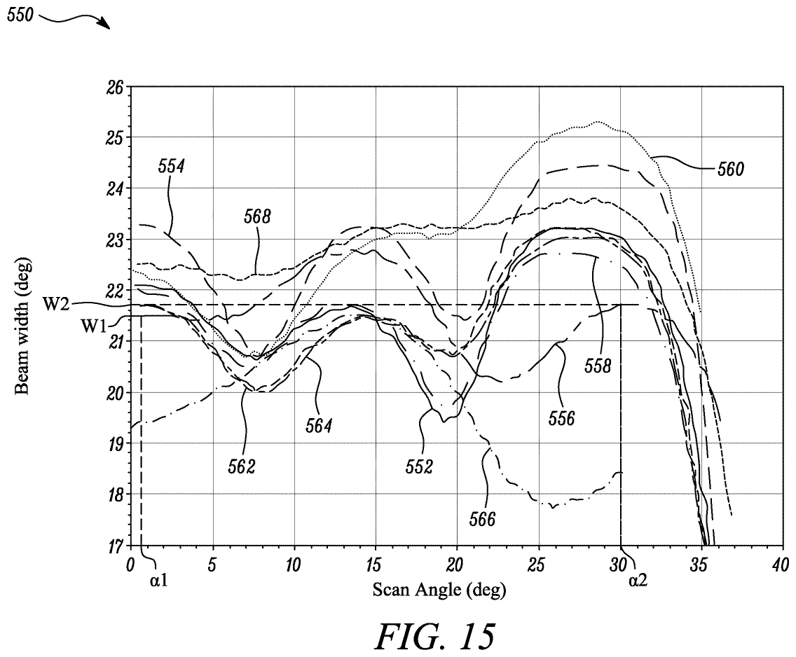

FIG. 15 illustrates a graph 550 depicting 3 dB beam width versus scan angle for the antenna assembly 300 of FIGS. 2 and 11 and the comparative antenna assembly, according to an embodiment of the present disclosure. The scan angle is expressed in degrees (deg) in the abscissa. The 3 dB beam width is expressed in degrees (deg) in the ordinate.

The graph 550 includes curves 552, 554, 556, 558, 560, 562, 564, 566, and 568. The curve 552 depicts 3 dB beam width versus scan angle for the antenna assembly 300 including the lens 20a (shown in FIGS. 4A to 4C). The curve 554 depicts 3 dB beam width versus scan angle for the antenna assembly 300 including the lens 20b (shown in FIGS. 5A and 5B). The curve 556 depicts 3 dB beam width versus scan angle for the antenna assembly 300 including the lens 20c (shown in FIGS. 6A to 6C). The curve 558 depicts 3 dB beam width versus scan angle for the antenna assembly 300 including the lens 20d (shown in FIGS. 7A to 7C). The curve 560 depicts 3 dB beam width versus scan angle for the antenna assembly 300 including the lens 20e (shown in FIGS. 8A to 8C). The curve 562 depicts 3 dB beam width versus scan angle for the antenna assembly 300 including the lens 20f (shown in FIGS. 9A to 9C). The curve 564 depicts 3 dB beam width versus scan angle versus for the antenna assembly 300 including the lens 20g (shown in FIGS. 10A to 10C). The curve 566 depicts 3 dB beam width versus scan angle for the comparative antenna assembly including the lens 22′ (shown in FIG. 13). The curve 568 depicts 3 dB beam width versus scan angle versus for an antenna assembly having a same construction as that of the antenna assembly 300 (shown in FIG. 2) except that it does not include any lens. In other words, the curve 568 depicts the 3 dB beam width versus scan angle of the phased array antenna 100 (shown in FIG. 2).

Referring to FIGS. 2, 12, 13, and 15, when the lens 20 is disposed on and substantially covers the plurality of spaced apart antenna elements 10 of the phased array antenna 100 with the second major surface 22 disposed between the structured first major surface 21 and the antenna elements 10, then in the scan plane 30, the antenna elements 10 steer the beam 90 in the scan plane 30 having a 3 dB beam width W1 when steered along the first direction 92 making the angle α1 of less than about 10 degrees with the normal 31. In other words, in the scan plane 30, the antenna assembly 300 steers the beam 90 in the scan plane 30 having the 3 dB beam width W1 when steered along the first direction 92 making the angle α1 of less than about 10 degrees with the normal 31. For illustrative purposes, W1 is labelled only for the antenna assembly 300 including the lens 20c of FIGS. 6A to 6C (depicted by the curve 556). In the graph 550, the angle α1 is about 0.8 degrees and W1 is about 21.5 degrees.

Further, when the lens 20 is disposed on and substantially covers the plurality of spaced apart antenna elements 10 of the phased array antenna 100 with the second major surface 22 disposed between the structured first major surface 21 and the antenna elements 10, then in the scan plane 30, the antenna elements 10 steer the beam 91 in the scan plane 30 having a 3 dB beam width W2 when steered along the second direction 93 making the angle α2 of no less than about 30 degrees with the normal 31. In other words, in the scan plane 30, the antenna assembly 300 steers the beam 91 in the scan plane 30 having the 3 dB beam width W2 when steered along the second direction 93 making the angle α2 of no less than about 30 degrees with the normal 31. For illustrative purposes, W2 is labelled only for the antenna assembly 300 including the lens 20c of FIGS. 6A to 6C (depicted by the curve 556). In the graph 550, the angle α2 is about 30 degrees and W2 is about 21.7 degrees. As is apparent from the curve 556, W1 and W2 are within 15% of each other.

For other curves 552, 554, 558, 560, 562, and 564, W1 and W2 are not labelled. However, from the curve 552, it is apparent that W1 and W2 are within 7% of each other. Further, from the curve 554, it is apparent that W1 and W2 are within 5% of each other. From the curve 558, it is apparent that W1 and W2 are within 5% of each other. Therefore, in some embodiments, W1 and W2 are within 12.5%, within 10%, within 7.5%, or within 5% of each other. It signifies that the 3 dB beam widths W1, W2 of the respective beams 90, 91 do not vary more than 15% when steered along the respective angles α1, α2 (α1 is less than about 10 degrees with the normal and α2 is equal to or greater than about 30 degrees with the normal 31). On the contrary, in the comparative antenna assembly, the 3 dB beam widths may vary more than 15% when a beam is steered along two different scan angles (i.e., one scan angle of less than about 10 degrees and another scan angle of equal to or greater than about 30 degrees). For example, for the angle α1 of about 9 degrees and the angle α2 of about 30 degrees in the comparative antenna assembly, the 3 dB beam widths vary more than 10%. Therefore, the antenna assembly 300 shows a relatively less variation in beam widths of a beam steered along two different angles α1, α2 (α1 is less than about 10 degrees with the normal and α2 is equal to or greater than about 30 degrees with the normal 31). In other words, the antenna assembly 300 may extend the azimuthal scan range, which could be otherwise limited due to the beam broadening. Further, additional cell sites may not be required to provide the same network coverage as the existing RAN cell sites.

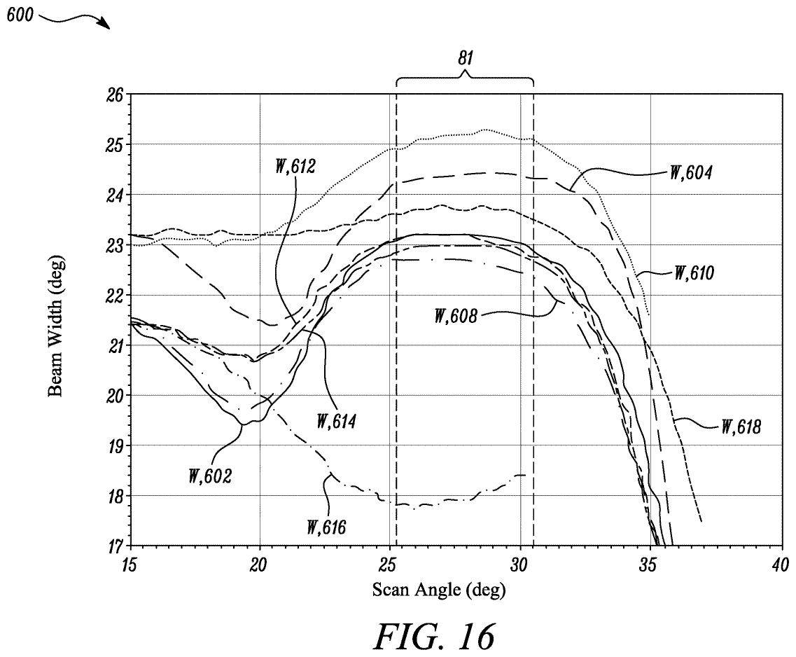

FIG. 16 illustrates a graph 600 depicting 3 dB beam width versus scan angle for the antenna assembly 300 of FIGS. 2 and 12 and the comparative antenna assembly, according to an embodiment of the present disclosure. The scan angle is expressed in degrees (deg) in the abscissa. The 3 dB beam width is expressed in degrees (deg) in the ordinate.

The graph 600 includes curves 602, 604, 608, 610, 612, 614, 616, and 618. The curve 602 depicts 3 dB beam width versus scan angle for the antenna assembly 300 including the lens 20a (shown in FIGS. 4A to 4C). The curve 604 depicts 3 dB beam width versus scan angle for the antenna assembly 300 including the lens 20b (shown in FIGS. 5A and 5B). The curve 608 depicts 3 dB beam width versus scan angle for the antenna assembly 300 including the lens 20d (shown in FIGS. 7A to 7C). The curve 610 depicts 3 dB beam width versus scan angle for the antenna assembly 300 including the lens 20e (shown in FIGS. 8A to 8C). The curve 612 depicts 3 dB beam width versus scan angle for the antenna assembly 300 including the lens 20f (shown in FIGS. 9A to 9C). The curve 614 depicts 3 dB beam width versus scan angle for the antenna assembly 300 including the lens 20g (shown in FIGS. 10A to 10C). The curve 616 depicts 3 dB beam width versus scan angle for the comparative antenna assembly including the lens 22′ (shown in FIG. 13). The curve 618 depicts 3 dB beam width versus scan angle for an antenna assembly having a same construction as that of the antenna assembly 300 (shown in FIG. 2) except that it does not include any lens. In other words, the curve 618 depicts the 3 dB beam width versus scan angle for the phased array antenna 100 (shown in FIG. 2).

Referring to FIGS. 2, 12, 13, and 16, when the lens 20 is disposed on and substantially covers the plurality of spaced apart antenna elements 10 of the phased array antenna 100, then in the scan plane 30, the antenna elements 10 steer the beam 90 in the scan plane 30 having a 3 dB beam width W and propagating in the scan plane 30 along the scan direction 92 making the scan angle α1 with the normal 31. For a scan angle of greater than about 15 degrees over a scan angle range 81 of at least 3 degrees, W varies by less than 5%. For example, with reference to the curve 602, for the scan angle of greater than about 15 degrees over the scan angle range 81 defined between 26 degrees and 31 degrees, W varies by less than 5%. In some embodiments, for the scan angle of greater than about 15 degrees over the scan angle range 81 of 3.5 degrees, 4 degrees, 4.5 degrees, or 5 degrees, W varies by less than 4%, less than 3%, less than 2%, or less than 1%. In some embodiments, for the scan angle of greater than about 17.5 degrees, greater than about 20 degrees, greater than about 22.5 degrees, or greater than about 25 degrees over the scan angle range 81 of at least 3 degrees, W varies by less than 5%. On the contrary, with reference to the curve 616, for a scan angle of greater than about 15 degrees over the scan angle range 81 of about 5 degrees, a 3 dB beam width of a beam steered by the comparative antenna assembly may show a relatively higher variation as compared to the antenna assembly 300 including the lens 20.

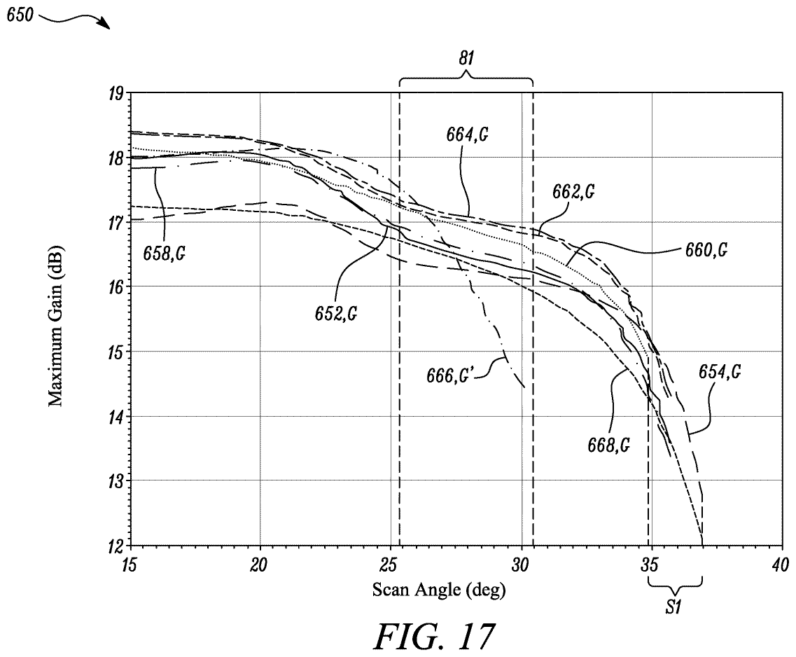

FIG. 17 illustrates a graph 650 depicting maximum gain versus scan angle for the antenna assembly 300 of FIGS. 2 and 12, and the comparative antenna assembly, according to an embodiment of the present disclosure. The scan angle is expressed in degrees (deg) in the abscissa. The maximum gain is expressed in decibels (dB) in the ordinate.

The graph 650 includes curves 652, 654, 658, 660, 662, 664, 666, and 668. The curve 652 depicts maximum gain versus scan angle for the antenna assembly 300 including the lens 20a (shown in FIGS. 4A to 4C). The curve 654 depicts maximum gain versus scan angle for the antenna assembly 300 including the lens 20b (shown in FIGS. 5A and 5B). The curve 658 depicts maximum gain versus scan angle for the antenna assembly 300 including the lens 20d (shown in FIGS. 7A to 7C). The curve 660 depicts maximum gain versus scan angle for the antenna assembly 300 including the lens 20e (shown in FIGS. 8A to 8C). The curve 662 depicts maximum gain versus scan angle for the antenna assembly 300 including the lens 20f (shown in FIGS. 9A to 9C). The curve 664 depicts maximum gain versus scan angle for the antenna assembly 300 including the lens 20g (shown in FIGS. 10A to 10C). The curve 666 depicts maximum gain versus scan angle for the comparative antenna assembly including the lens 22′ (shown in FIG. 13). The curve 668 depicts maximum gain versus scan angle for an antenna assembly having a same construction as that of the antenna assembly 300 (shown in FIG. 2) except that it does not include any lens.

Referring to FIGS. 2, 12, 13, and 17, the beam 90 propagating in the scan plane 30 along the scan direction 92 has a maximum gain G. For the scan angle of greater than about 15 degrees over the scan angle range 81 of at least 3 degrees, G varies by less than 15%. In some embodiments, for the scan angle of greater than about 15 degrees over the scan angle range 81 of 3.5 degrees, 4 degrees, 4.5 degrees, or 5 degrees, G varies by less than 12.5%, less than 10%, less than 7.5%, or less than 5%. In some embodiments, for the scan angle of greater than about 17.5 degrees, greater than about 20 degrees, greater than about 22.5 degrees, or greater than about 25 degrees over the scan angle range 81 of at least 3 degrees, G varies by less than 15%. On the contrary, with reference to the curve 666, for the scan angle of greater than about 15 degrees over the scan angle range 81 of about 5 degrees, a maximum gain of the comparative antenna assembly varies by more than 15%.

Further, in the scan plane 30, the antenna assembly 300 and the comparative antenna assembly steer respective beams 90, 91 in the scan plane 30 having respective maximum gains G, G′ terminating at respective maximum scan angles S1 and S1′. The maximum gain G′ is denoted by the curve 666.

As is apparent from the graph 650, S1 is greater than S1′ by at least 2 degrees. In some embodiments, S1 is greater than S1′ by at least 3 degrees, at least 4 degrees, at least 5 degrees, at least 6 degrees, or at least 7 degrees. As the scan angle S1 at which the maximum gain of a beam steered by the antenna assembly 300 terminates is greater than by at least 2 degrees than the scan angle S1′ at which the maximum gain of a beam steered by the comparative antenna assembly terminates, the antenna assembly 300 of the present disclosure may be operable at greater azimuthal scan angles than the comparative antenna assembly.

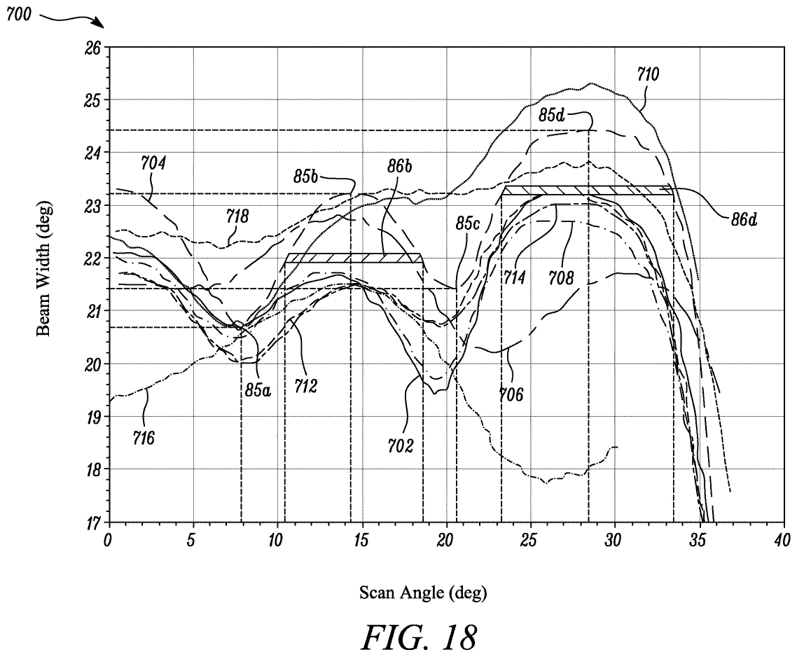

FIG. 18 illustrates a graph 700 depicting 3 dB beam width versus scan angle for the antenna assembly 300 of FIGS. 2 and 12 and the comparative antenna assembly, according to an embodiment of the present disclosure. The scan angle is expressed in degrees (deg) in the abscissa. The 3 dB beam width is expressed in degrees (deg) in the ordinate.

The graph 700 includes curves 702, 704, 706, 708, 710, 712, 714, 716, and 718. The curve 702 depicts 3 dB beam width versus scan angle for the antenna assembly 300 including the lens 20a (shown in FIGS. 4A to 4C). The curve 704 depicts 3 dB beam width versus scan angle for the antenna assembly 300 including the lens 20b (shown in FIGS. 5A and 5B). The curve 706 depicts 3 dB beam width versus scan angle for the antenna assembly 300 including the lens 20c (shown in FIGS. 6A to 6C). The curve 708 depicts 3 dB beam width versus scan angle for the antenna assembly 300 including the lens 20d (shown in FIGS. 7A to 7C). The curve 710 depicts 3 dB beam width versus scan angle for the antenna assembly 300 including the lens 20e (shown in FIGS. 8A to 8C). The curve 712 depicts 3 dB beam width versus scan angle for the antenna assembly 300 including the lens 20f (shown in FIGS. 9A to 9C). The curve 714 depicts 3 dB beam width versus scan angle for the antenna assembly 300 including the lens 20g (shown in FIGS. 10A to 10C). The curve 716 depicts 3 dB beam width versus scan angle for the comparative antenna assembly including the lens 22′ (shown in FIG. 13). The curve 718 depicts 3 dB beam width versus scan angle for an antenna assembly having a same construction as that of the antenna assembly 300 (shown in FIG. 2) except that it does not include any lens.

Referring to FIGS. 2, 12, 13, and 18, in the scan plane 30, the antenna assembly 300 steers a beam (i.e., the beams 90, 91) having a 3 dB beam width having a plurality of alternating peaks 85b, 85d and valleys 85a, 85c. For illustrative purposes, the alternating peaks 85b, 85d and valleys 85a, 85c are labelled only for the antenna assembly 300 including the lens 20b of FIGS. 5A and 5B (depicted by the curve 704). Each of at least two peaks 85b, 85d in the plurality of alternating peaks 85b, 85d and valleys 85a, 85c has a full width at 95% maximum FW95M (denoted by 86b, 86d) that is greater than about 2 degrees and less than about 20 degrees. In the illustrated embodiment of FIG. 17, the peak 85b has the full width at 95% maximum FW95M 86b of about 8 degrees and the peak 85d has the full width at 95% maximum FW95M 86d of about 10 degrees.

In some embodiments, FW95M 86b of the peak 85b is greater than about 3 degrees, 4 degrees, or 5 degrees and less than about 18 degrees, 15 degrees, 14 degrees, 12 degrees, or 10 degrees. In some embodiments, FW95M 86d of the peak 85d is greater than about 3 degrees, 4 degrees, 5 degrees, or 8 degrees and less than about 18 degrees, 15 degrees, 14 degrees, 12 degrees, or 8 degrees.

For other curves 702, 706, 708, 710, 712, and 714, the alternating peaks 85b, 85d and valleys 85a, 85c are not labelled. However, for the curves 702, 706, 708, 710, 712, and 714, each of at least two peaks in the plurality of alternating peaks and valleys also has a full width at 95% maximum that is greater than about 2 degrees and less than about 20 degrees.

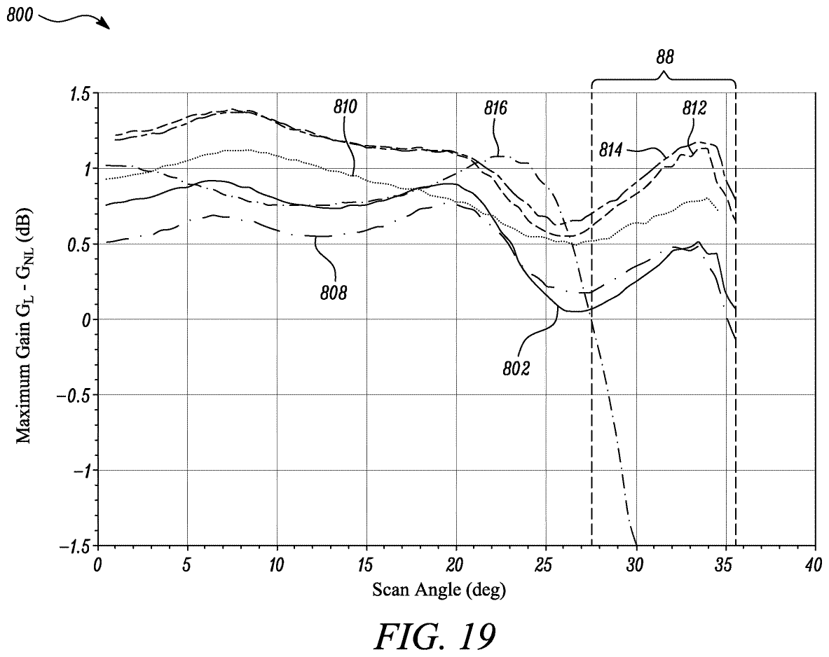

FIG. 19 illustrates a graph 800 depicting a difference of maximum gain G_{L} for the antenna assembly 300 of FIG. 12 and maximum gain G_{NL} for a comparative antenna assembly versus scan angle, according to an embodiment of the present disclosure. The scan angle is expressed in degrees (deg) in the abscissa. The maximum gain is expressed in decibels (dB) in the ordinate. The comparative antenna assembly has a same construction as that of the antenna assembly 300 except that it does not include a lens.

The graph 800 includes curves 802, 808, 810, 812, 814, and 816. The curve 802 depicts a difference of maximum gain G_{L} for the antenna assembly 300 including the lens 20a (shown in FIGS. 4A to 4C) and maximum gain G_{NL} for the comparative antenna assembly (with no lens) versus scan angle. The curve 808 depicts a difference of maximum gain G_{L} for the antenna assembly 300 including the lens 20d (shown in FIGS. 7A to 7C) and maximum gain G_{NL} for the comparative antenna assembly (with no lens) versus scan angle. The curve 810 depicts a difference of maximum gain G_{L} for the antenna assembly 300 including the lens 20e (shown in FIGS. 8A to 8C) and maximum gain G_{NL} for the comparative antenna assembly (with no lens) versus scan angle. The curve 812 depicts a difference of maximum gain G_{L} for the antenna assembly 300 including the lens 20f (shown in FIGS. 9A to 9C) and maximum gain G_{NL} for the comparative antenna assembly (with no lens) versus scan angle. The curve 814 depicts a difference of maximum gain G_{L} for the antenna assembly 300 including the lens 20g (shown in FIGS. 10A to 10C) and maximum gain G_{NL} for the comparative antenna assembly (with no lens) versus scan angle. The curve 816 depicts a difference of maximum gain G_{L} for a comparative antenna assembly 300 including the lens 22′ (shown in FIG. 13) and maximum gain G_{NL} for the comparative antenna assembly (with no lens) versus scan angle.

Referring to FIGS. 2, 12, and 19, the antenna assembly 300 and the comparative antenna assembly (with no lens) steer respective beams 90 in the scan plane 30 having respective maximum gains G_{L} and G_{NL}. For the scan angle of greater than about 15 degrees over a scan angle range 88 of at least 3 degrees, G_{L}>G_{NL}. In some embodiments, for the scan angle of greater than about 15 degrees over the scan angle range 88 of 3.5 degrees, 4 degrees, 4.5 degrees, or 5 degrees, G_{L}>G_{NL}. In some embodiments, for the scan angle of greater than about 17.5 degrees, greater than about 20 degrees, greater than about 22.5 degrees, or greater than about 25 degrees over the scan angle range 88 of at least 3 degrees, G_{L}>G_{NL}.

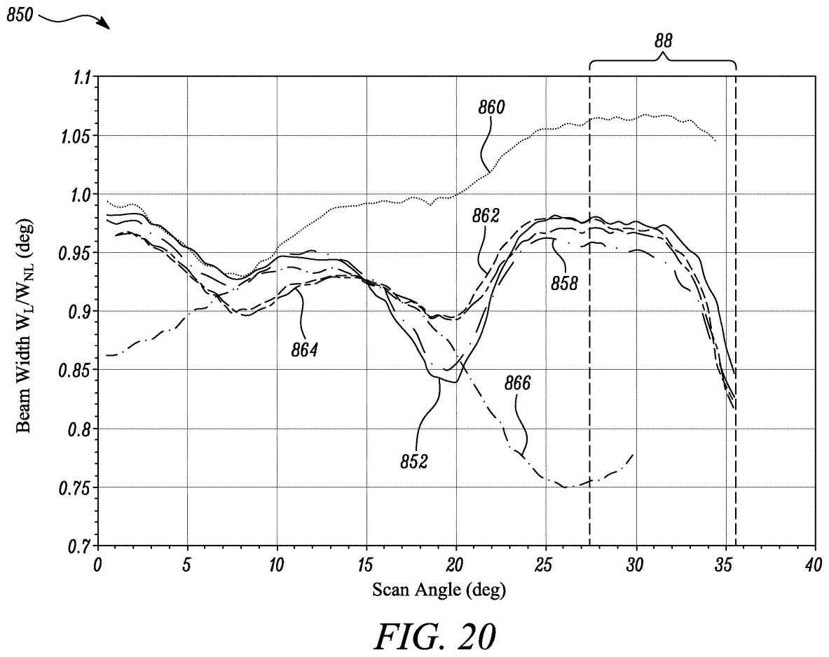

FIG. 20 illustrates a graph 850 depicting a ratio of 3 dB beam width W_{L} for the antenna assembly 300 of FIGS. 12 and 3 dB beam width W_{NL} for a comparative antenna assembly versus scan angle, according to an embodiment of the present disclosure. The scan angle is expressed in degrees (deg) in the abscissa. The 3 dB beam width is expressed in degrees (deg) in the ordinate. The comparative antenna assembly has a same construction as that of the antenna assembly 300 except that it does not include a lens.

The graph 850 includes curves 852, 858, 860, 862, 864, and 866. The curve 852 depicts a ratio of 3 dB beam width W_{L} for the antenna assembly 300 including the lens 20a (shown in FIGS. 4A to 4C) and 3 dB beam width W_{NL} for the comparative antenna assembly (with no lens) versus scan angle. The curve 858 depicts a ratio of 3 dB beam width W_{L} for the antenna assembly 300 including the lens 20d (shown in FIGS. 7A to 7C) and 3 dB beam width W_{NL} for the comparative antenna assembly (with no lens) versus scan angle. The curve 860 depicts a ratio of 3 dB beam width W_{L} for the antenna assembly 300 including the lens 20e (shown in FIGS. 8A to 8C) and 3 dB beam width W_{NL} for the comparative antenna assembly (with no lens) versus scan angle. The curve 862 depicts a ratio of 3 dB beam width W_{L} for the antenna assembly 300 including the lens 20f (shown in FIGS. 9A to 9C) and 3 dB beam width W_{NL} for the comparative antenna assembly (with no lens) versus scan angle. The curve 864 depicts a ratio of 3 dB beam width W_{L} for the antenna assembly 300 including the lens 20g (shown in FIGS. 10A to 10C) and 3 dB beam width W_{NL} for the comparative antenna assembly (with no lens) versus scan angle. The curve 866 depicts a ratio of 3 dB beam width W_{L} for a comparative antenna assembly 300 including the lens 22′ (shown in FIG. 13) and 3 dB beam width W_{NL} for the comparative antenna assembly (with no lens) versus scan angle.

Referring to FIGS. 2, 12, and 20, the antenna assembly 300 and the comparative antenna assembly (with no lens) steer respective beams 90 in the scan plane 30 having respective 3 dB beam widths W_{L} and W_{NL}. For the scan angle of greater than about 15 degrees over the scan angle range 88 of at least 3 degrees, W_{L}/W_{NL}>0.8. In some embodiments, for the scan angle of greater than about 15 degrees over the scan angle range 88 of 3.5 degrees, 4 degrees, 4.5 degrees, or 5 degrees, W_{L}/W_{NL}>0.8. In some embodiments, for the scan angle of greater than about 17.5 degrees, greater than about 20 degrees, greater than about 22.5 degrees, or greater than about 25 degrees over the scan angle range 88 of at least 3 degrees, W_{L}/W_{NL}>0.8.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A lens configured to be disposed on and substantially cover a plurality of spaced apart antenna elements of a phased array antenna, the lens comprising a structured first major surface opposite a second major surface, the structured first and second major surfaces defining a reference plane disposed inclusive therebetween and closest to the structured first major surface, the structured first major surface comprising a center and a first annular peak region surrounding, and substantially concentric with, the center, the first annular peak region having a first annular peak having an average separation P1 from the reference plane, a minimum separation between the structured first major surface and the reference plane inside the first annular peak being P2, P1/P2≥2.

2. The lens of claim 1, wherein the first annular peak region is a closed annulus having a continuous circumference.

3. The lens of claim 1, wherein the first annular peak region is an open annulus having a circumference comprising one or more discontinuities having a total length of less than about 30% of a total length of the circumference of the first annular peak region.

4. The lens of claim 1, wherein the second major surface is substantially planar.

5. The lens of claim 1, wherein the structured first major surface comprises a central cusp region at or near the center having an apex and a second annular peak region disposed between the center and the first annular peak region, the second annular peak region surrounding, and substantially concentric with, the center and comprising a second annular peak having an average separation P3 from the reference plane, P3<P1.

6. The lens of claim 1, wherein the first annular peak region defines a central hollow annular portion of the lens extending along a thickness direction from a first open end at the first annular peak to an opposite second open end at the second major surface, the first and second ends having respective maximum lateral dimensions D1 and D2, 0.5≤D2/D1<1.

7. The lens of claim 1, wherein the structured first major surface comprises a central cusp region at or near the center having an apex, the first annular peak region surrounding the apex.

8. The lens of claim 1, wherein the structured first major surface comprises a central convex peak region at or near the center having a peak, the first annular peak region surrounding the peak.

9. A lens configured to be disposed on and substantially cover a plurality of spaced apart antenna elements of a phased array antenna, the lens comprising a continuous closed annular first band comprising a corresponding continuous closed annular first band peak, the annular first band defining a cavity therein extending along a thickness direction of the lens from a first open end of the cavity at the first band peak to an opposite second end, the cavity having a maximum height Hc along the thickness direction of the lens, the first band having a height Hb1 along the thickness direction of the lens and a base having a width Wb1, Hc/Hb1≥0.5, Hb1>Wb1.

10. The lens of claim 9, wherein the second end is open.

11. The lens of claim 9 further comprising a protrusion near or at a center of the second end and protruding toward the first open end, the protrusion and the continuous closed annular first band defining a continuous closed annular first channel substantially co-extensive and concentric with the continuous closed annular first band.

12. An antenna assembly comprising:
a phased array antenna comprising a plurality of spaced apart antenna elements arranged in a plurality of rows and columns of the antenna elements and defining a first axis of symmetry; and
a non-spherical lens disposed on the phased array antenna and substantially covering at least some of the antenna elements, the non-spherical lens comprising a non-spherical first major surface facing away from the antenna elements and an opposite second major surface facing the antenna elements, the non-spherical first major surface comprising at least a curved portion curved along at least one direction;
such that in a scan plane that comprises the first axis of symmetry and a normal to the phased array antenna, the antenna assembly steers a beam in the scan plane having a maximum gain G1 and a 3 dB beam width W1 when steered along a first direction making an angle of less than about 10 degrees with the normal and a maximum gain G2 and a 3 dB beam width W2 when steered along a second direction making an angle of no less than about 30 degrees with the normal, G1 and G2 within 4 dB of each other, W1 and W2 within 15% of each other.

13. The antenna assembly of claim 12, wherein the non-spherical lens substantially covers at least 20% of the antenna elements.

14. The antenna assembly of claim 12, wherein the second major surface of the non-spherical lens and the antenna elements define a non-zero minimum gap therebetween.

15. The antenna assembly of claim 14, wherein the minimum gap is between about ⅛ to about ½ of a free-space wavelength of an operating frequency of the antenna assembly.
